(19) United States
(12) Patent Application Publication
(10) Pub. No.: US 2026/0075555 A1
(43) Pub. Date: Mar. 12, 2026

(54) TECHNIQUES FOR HANDLING COLLISION WITH DYNAMIC ADAPTATION OF SYNCHRONIZATION SIGNAL BLOCKS

(71) Applicant: QUALCOMM Incorporated, San Diego, CA (US)

(72) Inventors: Mohammed JABI, San Diego, CA (US); Ahmed Attia ABOTABL, San Diego, CA (US)

(21) Appl. No.: 18/827,076

(22) Filed: Sep. 6, 2024

(51) Int. Cl. H04W 56/00; H04W 72/1268; H04W 72/231; H04W 72/51

(52) U.S. Cl. CPC H04W 56/0015; H04W 72/1268; H04W 72/231; H04W 72/51

(57) ABSTRACT

Methods, systems, and devices for method for wireless communication are described. A user equipment (UE) may receive control information that indicates a set of communication occasions. The UE may then receive a first synchronization signal block (SSB) configuration that configures a first SSB transmission and a second SSB configuration that configures a second SSB transmission. The UE may select a set of the communication occasions for use by the UE, to avoid overlap with the first SSB transmission and the second SSB transmission. Additionally, or alternatively, the set of the communication occasions may be selected to avoid overlap with the second SSB transmission based on the second SSB configuration being a most recently activated configuration of the first SSB configuration and the second SSB configuration. The UE may communicate via the selected set of communication occasions.

### FIELD OF TECHNOLOGY

The following relates to methods for wireless communication, including techniques for handling collision with dynamic adaptation of synchronization signal blocks (SSBs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control information that indicates a set of multiple communication occasions, receiving a first synchronization signal block (SSB) configuration that configures a first SSB transmission, receiving a second SSB configuration that configures a second SSB transmission, selecting a set of the set of multiple communication occasions for use by the UE, where the set of the set of multiple communication occasions is selected to avoid overlap with the first SSB transmission and the second SSB transmission, and communicating via the set of the set of multiple communication occasions.

A UE for wireless communications is described. The UE may include one or more memories storing processor executable code, and one or more processors coupled with the one or more memories. The one or more processors may individually or collectively be operable to execute the code to cause the UE to receive control information that indicates a set of multiple communication occasions, receive a first SSB configuration that configures a first SSB transmission, receive a second SSB configuration that configures a second SSB transmission, select a set of the set of multiple communication occasions for use by the UE, where the set of the set of multiple communication occasions is selected to avoid overlap with the first SSB transmission and the second SSB transmission, and communicate via the set of the set of multiple communication occasions.

Another UE for wireless communications is described. The UE may include means for receiving control information that indicates a set of multiple communication occasions, means for receiving a first SSB configuration that configures a first SSB transmission, means for receiving a second SSB configuration that configures a second SSB transmission, means for selecting a set of the set of multiple communication occasions for use by the UE, where the set of the set of multiple communication occasions is selected to avoid overlap with the first SSB transmission and the second SSB transmission, and means for communicating via the set of the set of multiple communication occasions.

A non-transitory computer-readable medium storing code for wireless communications is described. The code may include instructions executable by one or more processors to receive control information that indicates a set of multiple communication occasions, receive a first SSB configuration that configures a first SSB transmission, receive a second SSB configuration that configures a second SSB transmission, select a set of the set of multiple communication occasions for use by the UE, where the set of the set of multiple communication occasions is selected to avoid overlap with the first SSB transmission and the second SSB transmission, and communicate via the set of the set of multiple communication occasions.

In some examples of the method, UEs, and non-transitory computer-readable medium described herein, the first SSB configuration configures a first set of SSB transmissions in accordance with a first periodicity and the second SSB configuration configures a second set of SSB transmissions in accordance with a second periodicity that may be different from the first periodicity and the first set of SSB transmissions include the first SSB transmission and the second set of SSB transmissions include the second SSB transmission.

In some examples of the method, UEs, and non-transitory computer-readable medium described herein, selecting the set of the set of multiple communication occasions may include operations, features, means, or instructions for selecting the set of the set of multiple communication occasions for use by the UE to avoid overlap with the first SSB transmission based on the second periodicity being greater than the first periodicity.

In some examples of the method, UEs, and non-transitory computer-readable medium described herein, the set of the set of multiple communication occasions may be selected to exclude ones of the set of multiple communication occasions that overlap with the first SSB transmission.

Some examples of the method, UEs, and non-transitory computer-readable medium described herein may further include operations, features, means, or instructions for receiving a signal configuring an SSB adaptation scheme for the UE, where selecting the set of the set of multiple communication occasions may be based on the SSB adaptation scheme.

Some examples of the method, UEs, and non-transitory computer-readable medium described herein may further include operations, features, means, or instructions for transmitting a capability indication indicating that the UE may be capable of selecting the set of the set of multiple communication occasions to avoid overlap with the first SSB transmission and the second SSB transmission.

In some examples of the method, UEs, and non-transitory computer-readable medium described herein, the set of multiple communication occasions includes downlink monitoring occasions, uplink transmission occasions corresponding to one or more configured grants, or both.

In some examples of the method, UEs, and non-transitory computer-readable medium described herein, the overlap includes at least one of a complete overlap with the first SSB transmission and the second SSB transmission, a partial overlap with the first SSB transmission and the second SSB transmission, or overlap between a threshold quantity of symbols prior to or after the set of multiple communication occasions and the first SSB transmission and the second SSB transmission.

In some examples of the method, UEs, and non-transitory computer-readable medium described herein, the set of the plurality of communication occasions is selected in accordance with the first SSB configuration and the second SSB configuration.

A method for wireless communications by a UE is described. The method may include receiving control information that indicates a set of multiple communication occasions, receiving a first SSB configuration that configures a first SSB transmission, receiving a second SSB configuration that configures a second SSB transmission, selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration, and communicating via the set of the set of multiple communication occasions.

A UE for wireless communications is described. The UE may include one or more memories storing processor executable code, and one or more processors coupled with the one or more memories. The one or more processors may individually or collectively be operable to execute the code to cause the UE to receive control information that indicates a set of multiple communication occasions, receive a first SSB configuration that configures a first SSB transmission, receive a second SSB configuration that configures a second SSB transmission, select a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration, and communicate via the set of the set of multiple communication occasions.

Another UE for wireless communications is described. The UE may include means for receiving control information that indicates a set of multiple communication occasions, means for receiving a first SSB configuration that configures a first SSB transmission, means for receiving a second SSB configuration that configures a second SSB transmission, means for selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration, and means for communicating via the set of the set of multiple communication occasions.

A non-transitory computer-readable medium storing code for wireless communications is described. The code may include instructions executable by one or more processors to receive control information that indicates a set of multiple communication occasions, receive a first SSB configuration that configures a first SSB transmission, receive a second SSB configuration that configures a second SSB transmission, select a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration, and communicate via the set of the set of multiple communication occasions.

In some examples of the method, UEs, and non-transitory computer-readable medium described herein, the first SSB configuration configures a first set of SSB transmissions in accordance with a first periodicity and the second SSB configuration configures a second set of SSB transmissions in accordance with a second periodicity that may be different from the first periodicity and the first set of SSB transmissions include the first SSB transmission and the second set of SSB transmissions include the second SSB transmission.

In some examples of the method, UEs, and non-transitory computer-readable medium described herein, the set of the set of multiple communication occasions may be selected to exclude ones of the set of multiple communication occasions that overlap with the second SSB transmission based on the second SSB configuration being the most recently activated configuration.

In some examples of the method, UEs, and non-transitory computer-readable medium described herein, the set of the set of multiple communication occasions may be selected to include ones of the set of multiple communication occasions that overlap with the first SSB transmission based on the first SSB configuration not being the most recently activated configuration.

Some examples of the method, UEs, and non-transitory computer-readable medium described herein may further include operations, features, means, or instructions for receiving a signal configuring an SSB adaptation scheme for the UE, where selecting the set of the set of multiple communication occasions may be based on the SSB adaptation scheme.

In some examples of the method, UEs, and non-transitory computer-readable medium described herein, the second SSB configuration may be activated after a threshold time period may have elapsed after receiving the second SSB configuration.

Some examples of the method, UEs, and non-transitory computer-readable medium described herein may further include operations, features, means, or instructions for transmitting a capability indication indicating that the UE may be capable of selecting the set of the set of multiple communication occasions to avoid overlap with the second SSB transmission in accordance with the most recently activated configuration of the first SSB configuration and the second SSB configuration.

In some examples of the method, UEs, and non-transitory computer-readable medium described herein, the second SSB configuration may be activated after the first SSB configuration may be activated.

In some examples of the method, UEs, and non-transitory computer-readable medium described herein, the set of multiple communication occasions includes downlink monitoring occasions, uplink transmission occasions corresponding to one or more configured grants, or both.

In some examples of the method, UEs, and non-transitory computer-readable medium described herein, the overlap includes at least one of a complete overlap with the second SSB transmission, a partial overlap with the second SSB transmission, or overlap between a threshold quantity of symbols prior to or after the set of multiple communication occasions and the second SSB transmission.

A method for wireless communications by a network entity is described. The method may include outputting control information that indicates a set of multiple communication occasions, outputting a first SSB configuration that configures a first SSB transmission, outputting a second SSB configuration that configures a second SSB transmission, and communicating via a set of the set of multiple communication occasions, where the set of the set of multiple communication occasions is selected to avoid overlap with the first SSB transmission and the second SSB transmission.

A network entity for wireless communications is described. The network entity may include one or more memories storing processor executable code, and one or more processors coupled with the one or more memories. The one or more processors may individually or collectively be operable to execute the code to cause the network entity to output control information that indicates a set of multiple communication occasions, output a first SSB configuration that configures a first SSB transmission, output a second SSB configuration that configures a second SSB transmission, and communicate via a set of the set of multiple communication occasions, where the set of the set of multiple communication occasions is selected to avoid overlap with the first SSB transmission and the second SSB transmission.

Another network entity for wireless communications is described. The network entity may include means for outputting control information that indicates a set of multiple communication occasions, means for outputting a first SSB configuration that configures a first SSB transmission, means for outputting a second SSB configuration that configures a second SSB transmission, and means for communicating via a set of the set of multiple communication occasions, where the set of the set of multiple communication occasions is selected to avoid overlap with the first SSB transmission and the second SSB transmission.

A non-transitory computer-readable medium storing code for wireless communications is described. The code may include instructions executable by one or more processors to output control information that indicates a set of multiple communication occasions, output a first SSB configuration that configures a first SSB transmission, output a second SSB configuration that configures a second SSB transmission, and communicate via a set of the set of multiple communication occasions, where the set of the set of multiple communication occasions is selected to avoid overlap with the first SSB transmission and the second SSB transmission.

In some examples of the method, network entities, and non-transitory computer-readable medium described herein, the first SSB configuration configures a first set of SSB transmissions in accordance with a first periodicity and the second SSB configuration configures a second set of SSB transmissions in accordance with a second periodicity that may be different from the first periodicity and the first set of SSB transmissions include the first SSB transmission and the second set of SSB transmissions include the second SSB transmission.

In some examples of the method, network entities, and non-transitory computer-readable medium described herein, the set of the set of multiple communication occasions may be selected to avoid overlap with the first SSB transmission based on the second periodicity being greater than the first periodicity.

In some examples of the method, network entities, and non-transitory computer-readable medium described herein, at least one of the set of multiple communication occasions may be canceled based on overlapping with the first SSB transmission.

Some examples of the method, network entities, and non-transitory computer-readable medium described herein may further include operations, features, means, or instructions for outputting a signal configuring an SSB adaptation scheme, where the set of the set of multiple communication occasions may be selected based on the SSB adaptation scheme.

Some examples of the method, network entities, and non-transitory computer-readable medium described herein may further include operations, features, means, or instructions for obtaining, from a UE, a capability indication indicating that the UE may be capable of selecting the set of the set of multiple communication occasions to avoid overlap with the first SSB transmission and the second SSB transmission.

In some examples of the method, network entities, and non-transitory computer-readable medium described herein, the set of multiple communication occasions includes downlink monitoring occasions, uplink transmission occasions corresponding to one or more configured grants, or both.

In some examples of the method, network entities, and non-transitory computer-readable medium described herein, the overlap includes at least one of a complete overlap with the first SSB transmission and the second SSB transmission, a partial overlap with the first SSB transmission and the second SSB transmission, or overlap between a threshold quantity of symbols prior to or after the set of multiple communication occasions and the first SSB transmission and the second SSB transmission.

In some examples of the method, network entities, and non-transitory computer-readable medium described herein, the set of the plurality of communication occasions is selected in accordance with the first SSB configuration and the second SSB configuration.

A method for wireless communications by a network entity is described. The method may include outputting control information that indicates a set of multiple communication occasions, outputting a first SSB configuration that configures a first SSB transmission, outputting a second SSB configuration that configures a second SSB transmission, and communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

A network entity for wireless communications is described. The network entity may include one or more memories storing processor executable code, and one or more processors coupled with the one or more memories. The one or more processors may individually or collectively be operable to execute the code to cause the network entity to output control information that indicates a set of multiple communication occasions, output a first SSB configuration that configures a first SSB transmission, output a second SSB configuration that configures a second SSB transmission, and communicate via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

Another network entity for wireless communications is described. The network entity may include means for outputting control information that indicates a set of multiple communication occasions, means for outputting a first SSB configuration that configures a first SSB transmission, means for outputting a second SSB configuration that configures a second SSB transmission, and means for communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

A non-transitory computer-readable medium storing code for wireless communications is described. The code may include instructions executable by one or more processors to output control information that indicates a set of multiple communication occasions, output a SSB configuration that configures a first SSB transmission, output a second SSB configuration that configures a second SSB transmission, and communicate via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

In some examples of the method, network entities, and non-transitory computer-readable medium described herein, the first SSB configuration configures a first set of SSB transmissions in accordance with a first periodicity and the second SSB configuration configures a second set of SSB transmissions in accordance with a second periodicity that may be different from the first periodicity and the first set of SSB transmissions include the first SSB transmission and the second set of SSB transmissions include the second SSB transmission.

In some examples of the method, network entities, and non-transitory computer-readable medium described herein, at least one of the set of multiple communication occasions may be canceled based on overlapping with the second SSB transmission.

In some examples of the method, network entities, and non-transitory computer-readable medium described herein, a communication occasion of the set of multiple communication occasions may be canceled after outputting the first SSB configuration and prior to outputting the second SSB configuration and the communication occasion may be canceled based on the communication occasion overlapping with the first SSB transmission.

In some examples of the method, network entities, and non-transitory computer-readable medium described herein, the canceled communication occasion may be activated based on outputting the second SSB configuration and the canceled communication occasion does not overlap with the second SSB transmission.

Some examples of the method, network entities, and non-transitory computer-readable medium described herein may further include operations, features, means, or instructions for outputting a signal configuring an SSB adaptation scheme, where the set of the set of multiple communication occasions may be selected based on the SSB adaptation scheme.

In some examples of the method, network entities, and non-transitory computer-readable medium described herein, the second SSB configuration may be activated after a threshold time period may have elapsed after outputting the second SSB configuration.

Some examples of the method, network entities, and non-transitory computer-readable medium described herein may further include operations, features, means, or instructions for obtaining, from a UE, a capability indication indicating that the UE may be capable of selecting the set of the set of multiple communication occasions to avoid overlap with the second SSB transmission in accordance with the most recently activated configuration of the first SSB configuration and the second SSB configuration.

In some examples of the method, network entities, and non-transitory computer-readable medium described herein, the second SSB configuration may be activated after the first SSB configuration may be activated.

In some examples of the method, network entities, and non-transitory computer-readable medium described herein, the set of multiple communication occasions includes downlink monitoring occasions, uplink transmission occasions corresponding to one or more configured grants, or both.

In some examples of the method, network entities, and non-transitory computer-readable medium described herein, the overlap includes at least one of a complete overlap with the second SSB transmission, a partial overlap with the second SSB transmission, or overlap between a threshold quantity of symbols prior to or after the set of multiple communication occasions and the second SSB transmission.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for handling collision with dynamic adaptation of synchronization signal blocks (SSBs) in accordance with various aspects of the present disclosure.

FIG. 2 shows an example of a wireless communications system that supports techniques for handling collision with dynamic adaptation of SSBs in accordance with various aspects of the present disclosure.

FIG. 3 shows an example of a communication timeline that supports techniques for handling collision with dynamic adaptation of SSBs in accordance with various aspects of the present disclosure.

FIG. 4 shows an example of a communication timeline that supports techniques for handling collision with dynamic adaptation of SSBs in accordance with various aspects of the present disclosure.

FIG. 5 shows an example of a process flow that supports techniques for handling collision with dynamic adaptation of SSBs in accordance with various aspects of the present disclosure.

FIGS. 6 and 7 show block diagrams of devices that support techniques for handling collision with dynamic adaptation of SSBs in accordance with various aspects of the present disclosure.

FIG. 8 shows a block diagram of a communications manager that supports techniques for handling collision with dynamic adaptation of SSBs in accordance with various aspects of the present disclosure.

FIG. 9 shows a diagram of a system including a device that supports techniques for handling collision with dynamic adaptation of SSBs in accordance with various aspects of the present disclosure.

FIGS. 10 and 11 show block diagrams of devices that support techniques for handling collision with dynamic adaptation of SSBs in accordance with various aspects of the present disclosure.

FIG. 12 shows a block diagram of a communications manager that supports techniques for handling collision with dynamic adaptation of SSBs in accordance with various aspects of the present disclosure.

FIG. 13 shows a diagram of a system including a device that supports techniques for handling collision with dynamic adaptation of SSBs in accordance with various aspects of the present disclosure.

FIGS. 14 through 18 show flowcharts illustrating methods that support techniques for handling collision with dynamic adaptation of SSBs in accordance with various aspects of the present disclosure.

### DETAILED DESCRIPTION

In some wireless communications systems, a user equipment (UE) and a network entity may communicate using one or more communication occasions. Such communication occasions may include uplink communication occasions or downlink communication occasions. Additionally, some wireless communications systems may support procedures for synchronization signal block (SSB) transmission. In some examples, SSB transmission may be scheduled according to an SSB configuration. For instance, a network entity may transmit a system information block 1 (SIB1) including one or more parameters related to an upcoming SSB transmission. In some examples, there may be a conflict between a scheduled communication occasion and an SSB transmission. For example, the SSB configuration may indicate an SSB periodicity, and an SSB transmission in accordance with the SSB periodicity may overlap with a scheduled communication occasion. In such cases, the UE may cancel or invalidate the communication occasion overlapping with the SSB transmission. In some examples, the UE and the network entity support dynamic adaptation of SSB in time domain. Dynamic adaptation of SSB may include adapting or updating SSB configuration (e.g., periodicity).

One or more aspects of the present disclosure provide for conflict resolution rules between communication occasions and SSB transmissions with a dynamic adaption of SSB configuration. For instance, implementing the techniques depicted herein, the UE may determine updated valid or invalid communication occasions after dynamic adaptation of an SSB configuration. In some examples, the UE may be configured with a set of communication occasions prior to receiving an SSB configuration. The UE may then receive a first SSB configuration that configures a first set of SSB transmissions and may then receive a second SSB configuration that configures a second set of SSB transmissions. The first SSB configuration may configure a first set of SSB transmissions in accordance with a first periodicity and the second SSB configuration may configure a second set of SSB transmissions in accordance with a second periodicity that is different from the first periodicity. In some examples, the UE may select one or more communication occasions to avoid overlap with the first set of SSB transmissions and the second set of SSB transmissions. For instance, the UE may consider both the first set of SSB transmissions in accordance with the first periodicity and the second set of SSB transmissions in accordance with the second periodicity to determine valid or invalid communication occasions. Additionally, or alternatively, the UE may select one or more communication occasions to avoid overlap with the second set of SSB transmissions based on the second SSB configuration being a most recently activated configuration of the first SSB configuration and the second SSB configuration. For instance, the UE may consider the second set of SSB transmissions in accordance with the second periodicity (e.g., the most recent SSB configuration) to determine valid or invalid communication occasions after receiving the second SSB configuration.

Aspects of the disclosure are initially described in the context of wireless communications systems. Aspects of the disclosure are further illustrated by and described with reference to communication timelines and a process flow. Aspects of the disclosure are further illustrated by and described with reference to apparatus diagrams, system diagrams, and flowcharts that relate to techniques for handling collision with dynamic adaptation of SSBs.

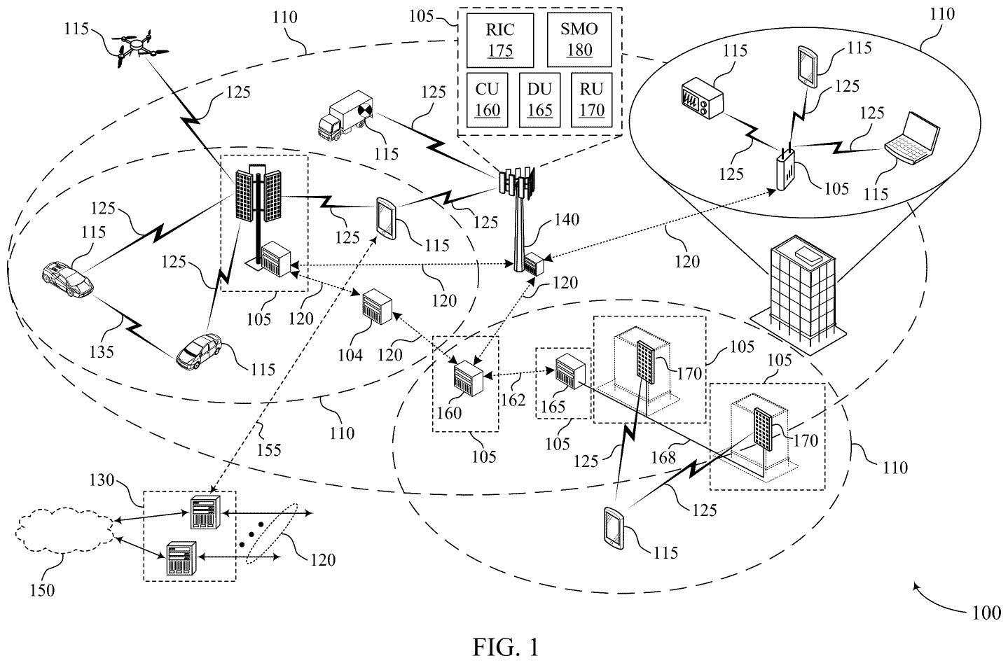

FIG. 1 shows an example of a wireless communications system 100 that supports techniques for handling collision with dynamic adaptation of SSBs in accordance with various aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along one or more orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may support procedures for on-demand SSB Secondary Cell (SCell) operation for UEs in connected mode configured with carrier aggregation (CA), for both intra-band CA or inter-band CA. In some examples, a UE 115 and a network entity 105 may support signaling methods to for an on-demand SIB1 for UEs in idle mode or inactive mode. Additionally, or alternatively, the wireless communications systems may adapt common signal transmissions or common channel transmissions. In some examples, the UE 115 and the network entity 105 support dynamic adaptation of SSB in time domain. Dynamic adaptation of SSB may include adapting the SSB transmission frequency for better (or greater) energy savings. The time adaptation can be dynamic and may be based on cell load. In some examples, the dynamic adaptation of SSB may include an adaptation of SSB burst periodicity, an adaptation based on two SSB configurations, an adaption based on skipping or transmitting one or more SSB bursts non-uniformly with a single SSB configuration, or an adaptation of a transmitted quantity of SSBs within an SSB burst, or any combination thereof.

In some wireless communications systems, the UE 115 and the network entity 105 may communicate using one or more communication occasions. Such communication occasions may include uplink communication occasions or downlink communication occasions. In some examples, there may be a collision between a scheduled communication occasion and an SSB. The UE 115 and the network entity 105 may implement a set of rules to address collision between semi statistic downlink, dynamic downlink, SSB, semi-static uplink and dynamic uplink.

In some examples, SSB transmissions may be prioritized in case of a collision with another communication occasion (e.g., a downlink communication occasion or an uplink communication occasion). As SSB blocks are used for some high priority tasks (e.g., initial time and frequency synchronization, identifying physical layer cell identity (PCI), measuring reference signal received power (RSRP), measuring reference signal received quality (RSRQ), measuring signal to noise ratio (SINR), one or more tracking operations, a radio resource management (RRM) measurement, and a radio link monitoring (RLM) measurement), an SSB from a serving cell may be prioritized. In some examples, SSB may have a higher priority over physical downlink control channel (PDCCH) monitoring and uplink transmission in a half-duplex UE (HD-UE).

In some examples, UE procedures for receiving control information may depend on the location of SSB blocks. A UE 115 may receive an indication of one or more PDCCH candidates (e.g., based on a periodicity). In such cases, the UE 115 may not monitor a PDCCH if there is a partial (or total) overlap between the set of resource elements used by PDCCH candidate and resource elements of a candidate SSB. Additionally, or alternatively, an HD-UE may not transmit physical uplink shared channel (PUSCH), PUCCH, physical random access channel (PRACH), and a sounding reference signal (SRS) if they overlap with the set of symbols used for SSB blocks withing an active bandwidth part.

In some examples, the UE 115 may receive an initial SSB configuration using either SIB1, ServingCellConfigCommon, SSB-MTCAdditionalPCI, or nonCellDefiningSSB. In some examples, the SSB related collision rules may relate to the set of resources used for SSB blocks which may be identified either in SIB1, ServingCellConfigCommon, SSB-MTCAdditionalPCI, or nonCellDefiningSSB. In some examples, the SSB configuration may be dynamically updated, which may improve network energy. For example, an initial SSB configuration may be provided to a UE 115 in SIB1. After providing the initial SSB configuration, the network entity 105 may dynamically update the SSB configuration, via downlink control information (DCI). In some examples, other mechanisms to update dynamically SSB configuration besides DCI may be considered. The aspects of the present disclosure provide for techniques for updating a validity and invalidity of communication occasions when a faster and dynamic indication of the SSB configuration is implemented. In particular, the aspects of the present disclosure define one or more rules for handling collision between communication occasions and SSB transmissions for dynamic updating of SSB configuration.

According to one or more aspects, a UE 115 may receive control information that indicates a set of communication occasions. The UE 115 may then receive a first SSB configuration that configures a first SSB transmission, and a second SSB configuration that configures a second SSB transmission. The UE 115, upon receiving the two SSB configurations may select one or more communication occasions for use by the UE 115. The selection of the one or more communication occasions may be to avoid overlap with the first SSB transmission and the second SSB transmission. Alternatively, the UE 115 may select the one or more communication occasions to avoid overlap with the second SSB transmission based on the second SSB configuration being a most recently activated configuration of the first SSB configuration and the second SSB configuration. The UE 115 may then communicate via the selected one or more communication occasions.

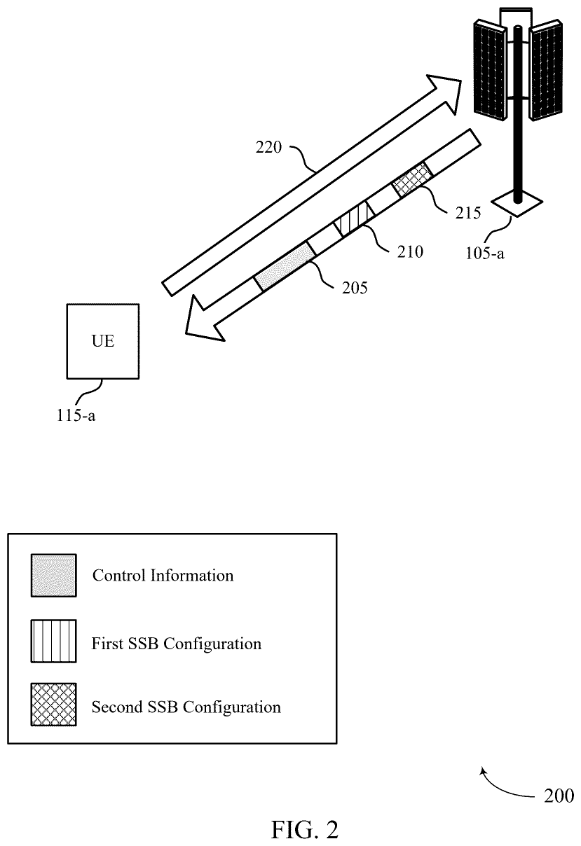

FIG. 2 shows an example of a wireless communications system 200 that supports techniques for handling collision with dynamic adaptation of SSBs in accordance with various aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1.

In some examples, the UE 115-a and the network entity 105-a may communicate in accordance with one or more rules to handle collisions between an SSB transmission and a communication occasion (e.g., uplink or downlink communication occasion). In some examples, the set of rules to address collision between SSB and PDCCH monitoring and uplink transmission in a HD-UE may be limited to the SSB configuration shared using SIB1, ServingCellConfigCommon, SSB-MTCAdditionalPCI, or nonCellDefiningSSB. In other words, validity or invalidity of PDCCH monitoring or uplink transmission in HD-UE occasions may be identified with respect to SSB configuration received via SIB1, ServingCellConfigCommon, SSB-MTCAdditionalPCI, or nonCellDefiningSSB. However, adaptation or changing the SSB configuration by, for instance, increasing or decreasing dynamically the periodicity of the SSB, may have an impact on the validity or invalidity of communication occasions (e.g., PDCCH monitoring occasions or uplink transmission occasions). In some examples, the UE 115-a may receive a configuration for a set of communication occasions (e.g., uplink communication occasions or downlink communication occasions). The UE 115-a may then receive a first SSB configuration that configures a set of SSB transmissions according to a first periodicity. The UE 115-a may determine that at least one of the communication occasions overlap with an SSB transmission. Accordingly, the UE 115-a may deactivate or cancel the communication occasion that overlaps with an SSB transmission in accordance with the first SSB configuration

Aspects depicted herein provide techniques for the UE 115-a to update the conflict resolution rules if the SSB configuration gets updated. For instance, the UE 115-a may first receive a control information 205 that indicates a set of communication occasions. The UE 115-a may then receive a first SSB configuration 210 that configures a first SSB transmission and a second SSB configuration 215 that configures a second SSB transmission. In some examples, the first SSB configuration 210 may configure a first set of SSB transmissions in accordance with a first SSB periodicity and the second SSB configuration 215 may configure a second set of SSB transmissions in accordance with a second SSB periodicity. The UE 115-a may select one or more communication occasions such that the selected communication occasions do not overlap with the SSB transmissions (e.g., at least one SSB transmission from the first set of SSB transmissions and the second set of SSB transmissions). The UE 115-a may implement one or more rules to select the one or more communication occasions. In some examples, the UE 115-a may receive the first SSB configuration 210 in SIB1. In some instances, the new SSB configuration (e.g., the second SSB configuration 215) may configure less SSB transmissions (e.g., periodicity increases compared to the one received initially in e.g., SIB1), and accordingly, one or more previously invalid occasions may become valid. Alternatively, the new SSB configuration (e.g., the second SSB configuration 215) may have more SSB transmissions (e.g., periodicity decreases compared to the one received initially in e.g., SIB1), and accordingly, one or more previously valid occasions may become invalid.

According to the one or more depicted herein, the UE 115-a may implement the conflict resolution rules to perform PDCCH monitoring and uplink transmission of PUSCH (e.g., HD-UE transmission), PUCCH transmission, PRACH transmission and SRS transmission in case of collision with SSB blocks. Such SSB blocks (or SSB transmissions) may change dynamically based on SSB configurations.

In some examples, the UE 115-a may determine active and inactive PDCCH monitoring candidates based on an initial periodicity (i.e., ssb-periodicity-1) associated with the first SSB configuration 210. At time t1, the periodicity may change to ssb-periodicity-2 associated with the second SSB configuration 215. As a consequence, some collisions with SSB may not be expected at one or more PDCCH monitoring candidates (e.g., due to the changes periodicity as a result of the dynamic changes in the SSB time pattern). In another example, at time t1, the periodicity may change to ssb-periodicity-2 associated with the second SSB configuration 215, where ssb-periodicity-2 is less than ssb-periodicity-1. As a consequence, some collisions with SSB may not be accounted for at one or more communication occasions (e.g., PDCCH monitoring candidates, PUSCH transmission, PUCCH transmission, PRACH transmission or SRS transmission) if the conflict resolution rule (e.g., collision rule) is based solely on the initial ssb-periodicity-1.

According to one or more aspects of the present disclosure, the conflict resolution rules may indicate that collision occasions of downlink monitoring and uplink transmissions with SSB blocks may assume an SSB configuration that it is the combination of all possible SSB configurations. Additionally, or alternatively, the conflict resolution rules may indicate that collision occasions of downlink monitoring and uplink transmissions with SSB blocks may assume the most recently activated SSB configuration for each time slot. The considered SSB blocks candidates may therefore be updated after each SSB configuration’ adaptation.

For instance, the UE 115-a may select one or more communication occasions to avoid overlap with the first SSB transmission and the second SSB transmission. Additionally, or alternatively, the UE may select one or more communication occasions to avoid overlap with the second SSB transmission based on the second SSB configuration being a most recently activated configuration of the first SSB configuration and the second SSB configuration. In some examples, the UE 115-a may then communicate (via communication link 220) using the selected one or more communication occasions.

In some examples, a communication occasion may be considered as invalid if it overlaps partially or totally with an SSB transmission. As used herein, an “overlap” or “collision” between an SSB transmission and communication occasion may refer to an SSB transmission and communication occasions, as specified by the conflict resolution rules, where an “overlap” may refer to partial or total overlap between the SSB transmission and the communication occasion. An “overlap” may also include an SSB within a specific duration threshold (or number of symbols) before or after a communication occasion., and it may be possible for the wireless communications system 200 to implement a more general “invalidity” rule or criteria. For instance, a communication occasion may be declared invalid if the number of symbols between the SSB and the first/or last symbol of the communication occasion is less than a predefined number of symbols (N_gap, for instance).

In some examples, the conflict resolution rules may not assume restrictions on how SSB adaptation is triggered, which signaling is used to share the updated SSB configurations, and how the adaptation is performed. For instance, the network entity 105-a may provide support for SSB adaptation may in response to receiving a trigger (e.g., capability report) from the UE 115-a. Additionally, or alternatively, the conflict resolution rules may include one or more timing restrictions that are indicated during the adaptation of SSB configuration. For instance, while the transition to ssb-periodicity-2 may be announced at time t1, the network entity 105-a may configure the UE 115-a to start using the new SSB configuration after time t2. In this case, the SSB configuration update may be implemented after time t2.

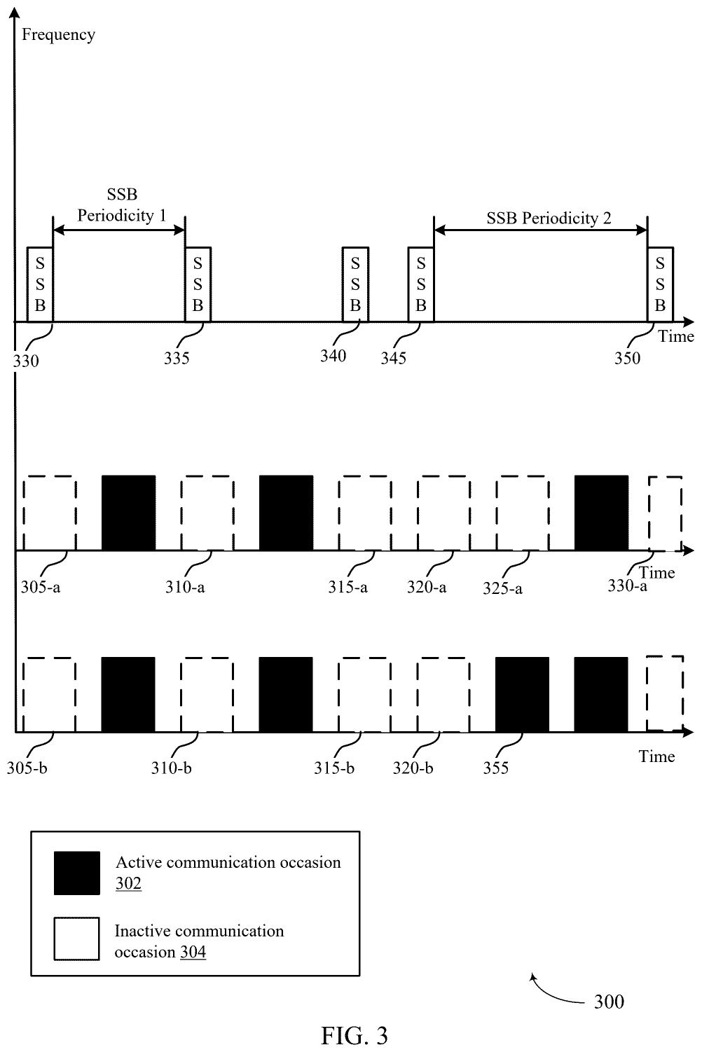

FIG. 3 shows an example of a communication timeline 300 that supports techniques for handling collision with dynamic adaptation of SSBs in accordance with various aspects of the present disclosure. The communication timeline 300 may implement or may be implemented by aspects of the wireless communications system 100 or the wireless communications system 200 as described with reference to FIG. 1 and FIG. 2. For example, the communication timeline 300 may be implemented by a UE 115 and a network entity 105, which may be examples of corresponding devices described with reference to FIG. 1 and FIG. 2.

According to one or more aspects depicted herein, the UE 115 may communicate with a network entity 105 in accordance with a conflict resolution rule that handles overlap between one or more communication occasions and one or more SSB transmissions. As depicted in the example of FIG. 3, the UE 115 receives a control signal that schedules one or more communication occasions (e.g., active communication occasions 302 and inactive communication occasions 304). The UE 115 may receive a first SSB configuration configurating SSB transmissions according to SSB periodicity 1. The UE 115 may determine SSB transmission 330, SSB transmission 335, and SSB transmission 340 based on the first SSB configuration. The UE 115 may then receive updated SSB configuration (e.g., second SSB configuration) configurating SSB transmissions according to SSB periodicity 2. The UE 115 may determine SSB transmission 345 and SSB transmission 350 based on the second SSB configuration.

The conflict resolution rule may indicate that collision occasions of communication occasions (e.g., PDCCH monitoring and HD-UE uplink transmissions) with SSB blocks may assume an SSB configuration that it is the combination of all possible SSB configurations. For example, based on the conflict resolution rule, the UE 115 may determine active and inactive communication occasions based on both SSB periodicity 1 and SSB periodicity 2 (e.g., based on first SSB configuration and second SSB configuration). As depicted herein, SSB periodicity 1 may be less than SSB periodicity 2. In such an example, the UE 115 may determine that the communication occasion 305-a, the communication occasion 310-a, the communication occasion 315-a, the communication occasion 320-a, the communication occasion 325-a, and the communication occasion 330-a are inactive due to collision or potential collision with one or more SSB transmissions. In this example, the UE 115 considers both SSB periodicity 1 and SSB periodicity 2 to determine the inactive communication occasions. As depicted in the example of FIG. 3, the UE 115 may consider that the communication occasion 305-a, the communication occasion 310-a, the communication occasion 315-a, the communication occasion 325-a are inactive due to a potential collision with an SSB transmission in accordance with SSB periodicity 1. Additionally, the UE 115 may consider that the communication occasion 310-a, the communication occasion 320-a, and the communication occasion 330-a are inactive due to a potential collision with an SSB transmission in accordance with SSB periodicity 2.

As depicted herein, the UE 115 may assume the shortest SSB-periodicity (e.g., SSB periodicity 1, in this example) irrespective of which periodicity is used at a given time instant. For instance, using this conflict resolution rule, the communication occasion 325-a may not be used by the UE 115 even if they are not interfering with SSB blocks (in accordance with SSB periodicity 2). In some examples, this conflict resolution rule may assume that the set of all SSB configurations is to be used during the adaptation of SSB. In such cases, the allowed SSB configurations may be limited and may be configured initially.

In some examples, the conflict resolution rule may indicate that collision occasions of communication occasions (e.g., PDCCH monitoring and HD-UE uplink transmissions) with SSB blocks may assume the most recent activated SSB configuration at each time slot. In some instances, the SSB blocks candidates considered by the UE 115 may be updated after each SSB configuration adaptation. For example, based on the conflict resolution rule, the UE 115 may determine active and inactive communication occasions (e.g., PDCCH candidates) based on the most recently activated configuration between the first SSB configuration and the second SSB configuration. In this example, the UE 115 may utilize the SSB periodicity 2 to determine active and inactive communication occasions upon switching the SSB configuration to the second SSB configuration. As depicted herein, SSB periodicity 1 may be less than SSB periodicity 2. In such an example, the UE 115 may determine that the communication occasion 305-b, communication occasion 310-b, the communication occasion 315-b, and the communication occasion 320-b are inactive due to collision or potential collision with one or more SSB transmissions. In this example, the UE 115 actives the communication occasion 355 as it considers the most recent SSB configuration to determine the inactive communication occasions.

Using such conflict resolution rules, the UE 115 may initially use an SSB configuration provided by the network entity 105 and may then switch to the adaptive SSB configuration, if any, provided by the network entity 105. The conflict resolution rule using the most recent activated SSB configuration at each time slot may allow efficient use of the communication channel and quick access to resources. Moreover, the UE 115 and the network entity 105 may communicate using such conflict resolution rules without knowledge of other SSB configurations a priori, which allows for flexible adaptation of the SSB configurations.

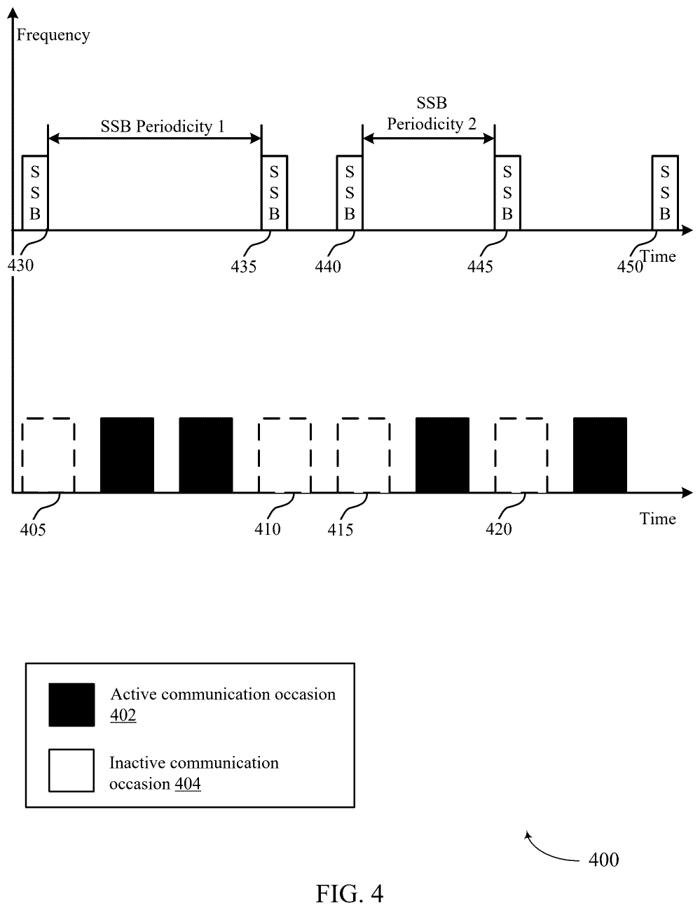

FIG. 4 shows an example of a communication timeline 400 that supports techniques for handling collision with dynamic adaptation of SSBs in accordance with various aspects of the present disclosure. The communication timeline 400 may implement or may be implemented by aspects of the wireless communications system 100 or the wireless communications system 200 as described with reference to FIG. 1 and FIG. 2. For example, the communication timeline 400 may be implemented by a UE 115 and a network entity 105, which may be examples of corresponding devices described with reference to FIG. 1 and FIG. 2.

According to one or more aspects depicted herein, the UE 115 may communicate with a network entity 105 in accordance with a conflict resolution rule that handles overlap between one or more communication occasions and one or more SSB transmissions. As depicted in the example of FIG. 4, the UE 115 receives a control signal that schedules one or more communication occasions (e.g., active communication occasions 402 and inactive communication occasions 404). The UE 115 may receive a first SSB configuration configurating SSB transmissions according to SSB periodicity 1. The UE 115 may determine SSB transmission 430 and SSB transmission 435 based on the first SSB configuration. The UE 115 may then receive updated SSB configuration (e.g., second SSB configuration) configurating SSB transmissions according to SSB periodicity 2. The UE 115 may determine SSB transmission 440, SSB transmission 445, and SSB transmission 450 based on the second SSB configuration.

The conflict resolution rule may indicate that collision occasions of communication occasions (e.g., PDCCH monitoring and HD-UE uplink transmissions) with SSB blocks may assume the most recent activated SSB configuration at each time slot. For example, based on the conflict resolution rule, the UE 115 may determine active and inactive communication occasions based on the most recently activated configuration between the first SSB configuration and the second SSB configuration. As depicted herein, SSB periodicity 1 may be greater than SSB periodicity 2. In such an example, the UE 115 may determine that the communication occasion 405, the communication occasion 410, the communication occasion 415, and the communication occasion 420 are inactive due to collision or potential collision with one or more SSB transmissions. In this example, the UE 115 considers SSB periodicity 1 to determine the inactive communication occasions prior to switching to SSB periodicity 2. The UE 115 then considers SSB periodicity 2 to determine the inactive communication occasions.

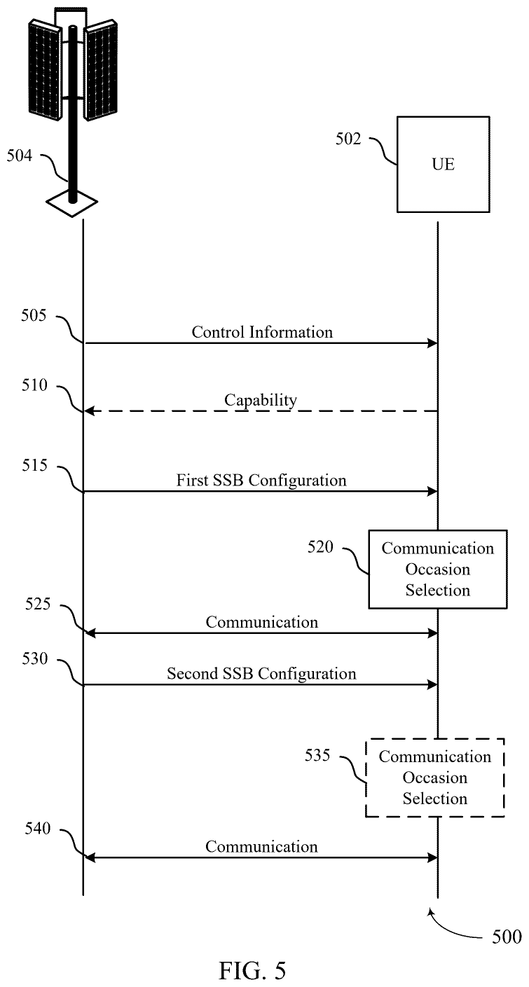

FIG. 5 shows an example of a process flow 500 that supports techniques for handling collision with dynamic adaptation of SSBs in accordance with various aspects of the present disclosure. The process flow 500 includes a UE 502 and a network entity 504, which may be examples of the corresponding devices as described with respect to FIGS. 1 and 2.

In the following description of the process flow 500, the operations between the UE 502 and the network entity 504 may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 502 may receive control information that indicates a quantity of communication occasions.

At 510, the UE 502 may optionally transmit a capability indication indicating that the UE 502 is capable of selecting a set of the quantity of communication occasions to avoid overlap with a first SSB transmission and a second SSB transmission. Additionally, or alternatively, the UE 502 may optionally transmit a capability indication indicating that the UE 502 is capable of selecting a set of the quantity of communication occasions to avoid overlap with the second SSB transmission in accordance with the most recently activated configuration of the first SSB configuration and the second SSB configuration.

At 515, the UE 502 may receive a first SSB configuration that configures a first SSB transmission. At 520, the UE 502 may select a set of communication occasions for use by the UE 502. In some examples, the set of communication occasions may be selected to avoid overlap with the first SSB transmission in accordance with the first SSB configuration. In some examples, the set of communication occasions may be selected to avoid overlap with the first SSB transmission based on the first SSB configuration being a most recently activated configuration.

At 525, the UE 502 may communicate with the network entity 504 via the selected set of communication occasions.

At 530, the UE 502 may receive a second SSB configuration that configures a second SSB transmission. In some examples, the first SSB configuration configures a first set of SSB transmissions in accordance with a first periodicity and the second SSB configuration configures a second set of SSB transmissions in accordance with a second periodicity that is different from the first periodicity. In such cases, the first set of SSB transmissions may include the first SSB transmission and the second set of SSB transmissions may include the second SSB transmission.

At 535, the UE 502 may optionally select a set of the quantity of communication occasions for use by the UE 502. In some examples, the set of communication occasions may be selected to avoid overlap with the first SSB transmission and the second SSB transmission. In some examples, the set of communication occasions may be selected to avoid overlap with the second SSB transmission based on the second SSB configuration being a most recently activated configuration of the first SSB configuration and the second SSB configuration.

At 540, the UE 502 may communicate with the network entity 504 via the selected set of communication occasions.

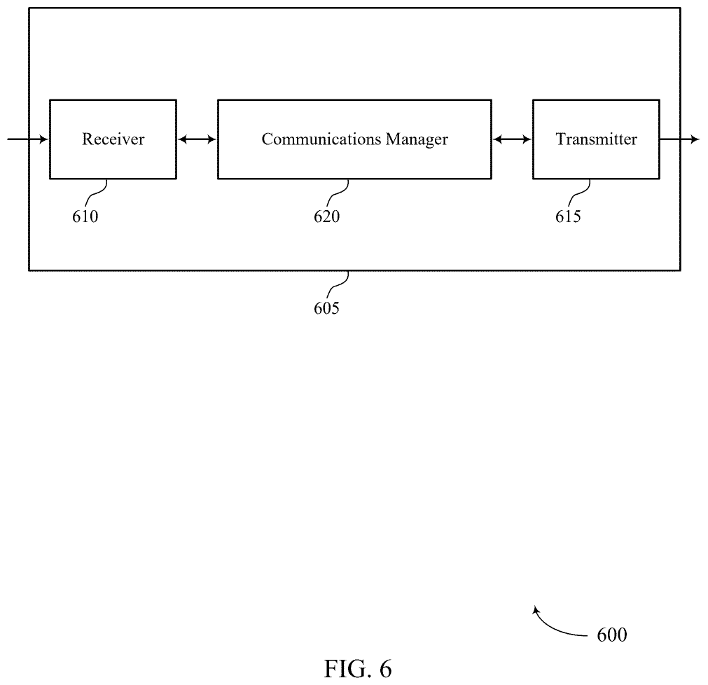

FIG. 6 shows a block diagram 600 of a device 605 that supports techniques for handling collision with dynamic adaptation of SSBs in accordance with various aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for handling collision with dynamic adaptation of SSBs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for handling collision with dynamic adaptation of SSBs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for handling collision with dynamic adaptation of SSBs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control information that indicates a set of multiple communication occasions. The communications manager 620 is capable of, configured to, or operable to support a means for receiving a first SSB configuration that configures a first SSB transmission. The communications manager 620 is capable of, configured to, or operable to support a means for receiving a second SSB configuration that configures a second SSB transmission. The communications manager 620 is capable of, configured to, or operable to support a means for selecting a set of the set of multiple communication occasions for use by the UE, where the set of the set of multiple communication occasions is selected to avoid overlap with the first SSB transmission and the second SSB transmission. The communications manager 620 is capable of, configured to, or operable to support a means for communicating via the set of the set of multiple communication occasions.

Additionally, or alternatively, the communications manager 620 may support wireless communications in accordance with examples as disclosed herein. For example, the communications manager 620 is capable of, configured to, or operable to support a means for receiving control information that indicates a set of multiple communication occasions. The communications manager 620 is capable of, configured to, or operable to support a means for receiving a first SSB configuration that configures a first SSB transmission. The communications manager 620 is capable of, configured to, or operable to support a means for receiving a second SSB configuration that configures a second SSB transmission. The communications manager 620 is capable of, configured to, or operable to support a means for selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration. The communications manager 620 is capable of, configured to, or operable to support a means for communicating via the set of the set of multiple communication occasions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

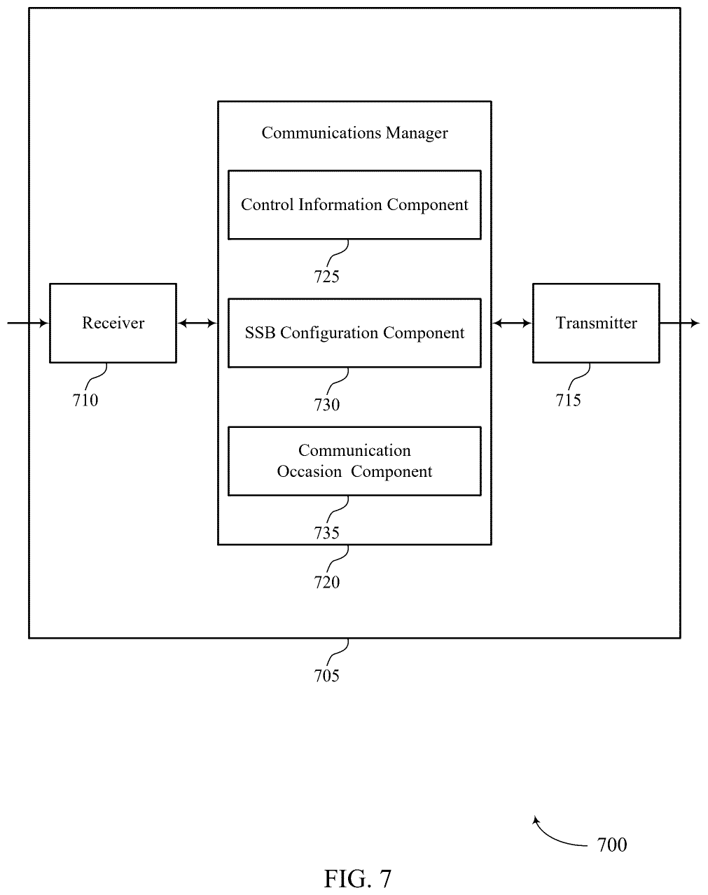

FIG. 7 shows a block diagram 700 of a device 705 that supports techniques for handling collision with dynamic adaptation of SSBs in accordance with various aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for handling collision with dynamic adaptation of SSBs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for handling collision with dynamic adaptation of SSBs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for handling collision with dynamic adaptation of SSBs as described herein. For example, the communications manager 720 may include a control information component 725, an SSB configuration component 730, a communication occasion component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control information component 725 is capable of, configured to, or operable to support a means for receiving control information that indicates a set of multiple communication occasions. The SSB configuration component 730 is capable of, configured to, or operable to support a means for receiving a first SSB configuration that configures a first SSB transmission. The SSB configuration component 730 is capable of, configured to, or operable to support a means for receiving a second SSB configuration that configures a second SSB transmission. The communication occasion component 735 is capable of, configured to, or operable to support a means for selecting a set of the set of multiple communication occasions for use by the UE, where the set of the set of multiple communication occasions is selected to avoid overlap with the first SSB transmission and the second SSB transmission. The communication occasion component 735 is capable of, configured to, or operable to support a means for communicating via the set of the set of multiple communication occasions.

Additionally, or alternatively, the communications manager 720 may support wireless communications in accordance with examples as disclosed herein. The control information component 725 is capable of, configured to, or operable to support a means for receiving control information that indicates a set of multiple communication occasions. The SSB configuration component 730 is capable of, configured to, or operable to support a means for receiving a first SSB configuration that configures a first SSB transmission. The SSB configuration component 730 is capable of, configured to, or operable to support a means for receiving a second SSB configuration that configures a second SSB transmission. The communication occasion component 735 is capable of, configured to, or operable to support a means for selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration. The communication occasion component 735 is capable of, configured to, or operable to support a means for communicating via the set of the set of multiple communication occasions.

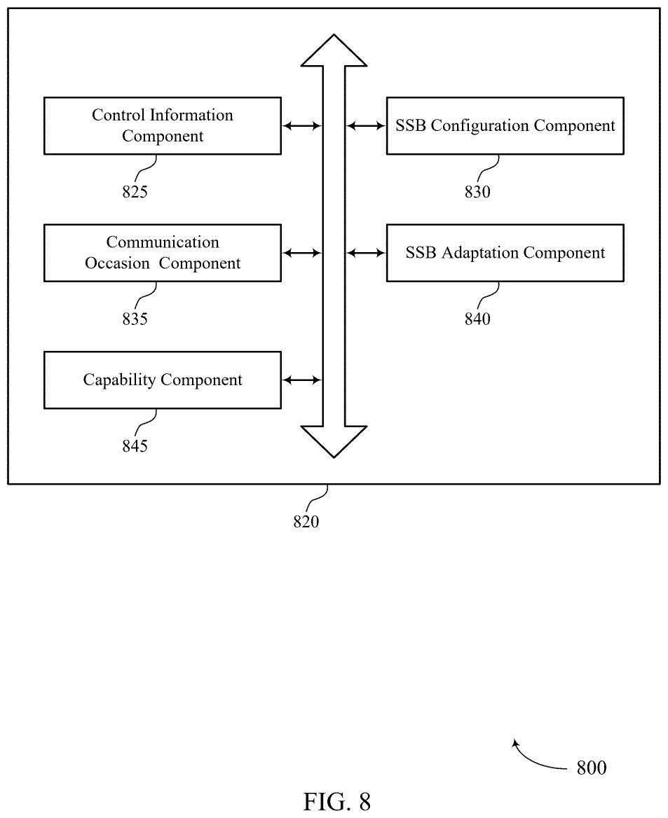

FIG. 8 shows a block diagram 800 of a communications manager 820 that supports techniques for handling collision with dynamic adaptation of SSBs in accordance with various aspects of the present disclosure. The communications manager 820 may be an example of aspects of a communications manager 620, a communications manager 720, or both, as described herein. The communications manager 820, or various components thereof, may be an example of means for performing various aspects of techniques for handling collision with dynamic adaptation of SSBs as described herein. For example, the communications manager 820 may include a control information component 825, an SSB configuration component 830, a communication occasion component 835, an SSB adaptation component 840, a capability component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control information component 825 is capable of, configured to, or operable to support a means for receiving control information that indicates a set of multiple communication occasions. The SSB configuration component 830 is capable of, configured to, or operable to support a means for receiving a first SSB configuration that configures a first SSB transmission. In some examples, the SSB configuration component 830 is capable of, configured to, or operable to support a means for receiving a second SSB configuration that configures a second SSB transmission. The communication occasion component 835 is capable of, configured to, or operable to support a means for selecting a set of the set of multiple communication occasions for use by the UE, where the set of the set of multiple communication occasions is selected to avoid overlap with the first SSB transmission and the second SSB transmission. In some examples, the communication occasion component 835 is capable of, configured to, or operable to support a means for communicating via the set of the set of multiple communication occasions.

In some examples, the first SSB configuration configures a first set of SSB transmissions in accordance with a first periodicity and the second SSB configuration configures a second set of SSB transmissions in accordance with a second periodicity that is different from the first periodicity. In some examples, the first set of SSB transmissions include the first SSB transmission and the second set of SSB transmissions include the second SSB transmission.

In some examples, to support selecting the set of the set of multiple communication occasions, the communication occasion component 835 is capable of, configured to, or operable to support a means for selecting the set of the set of multiple communication occasions for use by the UE to avoid overlap with the first SSB transmission based on the second periodicity being greater than the first periodicity. In some examples, the set of the set of multiple communication occasions is selected to exclude ones of the set of multiple communication occasions that overlap with the first SSB transmission.

In some examples, the SSB adaptation component 840 is capable of, configured to, or operable to support a means for receiving a signal configuring an SSB adaptation scheme for the UE, where selecting the set of the set of multiple communication occasions is based on the SSB adaptation scheme.

In some examples, the capability component 845 is capable of, configured to, or operable to support a means for transmitting a capability indication indicating that the UE is capable of selecting the set of the set of multiple communication occasions to avoid overlap with the first SSB transmission and the second SSB transmission. In some examples, the set of multiple communication occasions includes downlink monitoring occasions, uplink transmission occasions corresponding to one or more configured grants, or both.

In some examples, the overlap includes at least one of a complete overlap with the first SSB transmission and the second SSB transmission, a partial overlap with the first SSB transmission and the second SSB transmission, or overlap between a threshold quantity of symbols prior to or after the set of multiple communication occasions and the first SSB transmission and the second SSB transmission.

Additionally, or alternatively, the communications manager 820 may support wireless communications in accordance with examples as disclosed herein. In some examples, the control information component 825 is capable of, configured to, or operable to support a means for receiving control information that indicates a set of multiple communication occasions. In some examples, the SSB configuration component 830 is capable of, configured to, or operable to support a means for receiving a first SSB configuration that configures a first SSB transmission. In some examples, the SSB configuration component 830 is capable of, configured to, or operable to support a means for receiving a second SSB configuration that configures a second SSB transmission. In some examples, the communication occasion component 835 is capable of, configured to, or operable to support a means for selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration. In some examples, the communication occasion component 835 is capable of, configured to, or operable to support a means for communicating via the set of the set of multiple communication occasions.

In some examples, the first SSB configuration configures a first set of SSB transmissions in accordance with a first periodicity and the second SSB configuration configures a second set of SSB transmissions in accordance with a second periodicity that is different from the first periodicity. In some examples, the first set of SSB transmissions include the first SSB transmission and the second set of SSB transmissions include the second SSB transmission.

In some examples, the set of the set of multiple communication occasions is selected to exclude ones of the set of multiple communication occasions that overlap with the second SSB transmission based on the second SSB configuration being the most recently activated configuration.

In some examples, the set of the set of multiple communication occasions is selected to include ones of the set of multiple communication occasions that overlap with the first SSB transmission based on the first SSB configuration not being the most recently activated configuration.

In some examples, the SSB adaptation component 840 is capable of, configured to, or operable to support a means for receiving a signal configuring an SSB adaptation scheme for the UE, where selecting the set of the set of multiple communication occasions is based on the SSB adaptation scheme. In some examples, the second SSB configuration is activated after a threshold time period has elapsed after receiving the second SSB configuration.

In some examples, the capability component 845 is capable of, configured to, or operable to support a means for transmitting a capability indication indicating that the UE is capable of selecting the set of the set of multiple communication occasions to avoid overlap with the second SSB transmission in accordance with the most recently activated configuration of the first SSB configuration and the second SSB configuration.

In some examples, the second SSB configuration is activated after the first SSB configuration is activated. In some examples, the set of multiple communication occasions includes downlink monitoring occasions, uplink transmission occasions corresponding to one or more configured grants, or both.

In some examples, the overlap includes at least one of a complete overlap with the second SSB transmission, a partial overlap with the second SSB transmission, or overlap between a threshold quantity of symbols prior to or after the set of multiple communication occasions and the second SSB transmission.

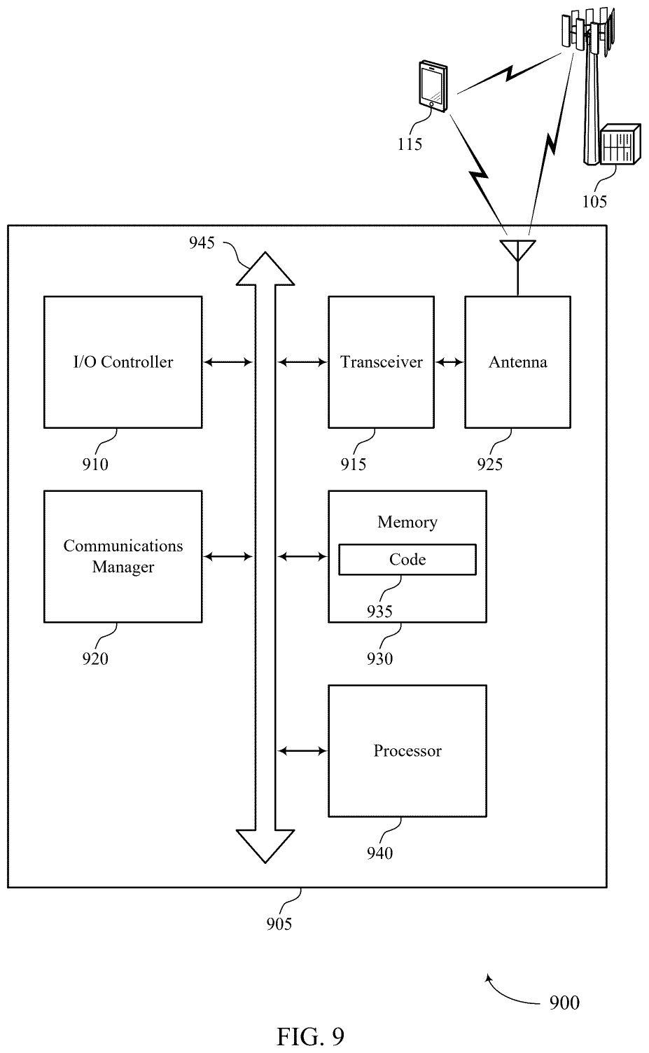

FIG. 9 shows a diagram of a system 900 including a device 905 that supports techniques for handling collision with dynamic adaptation of SSBs in accordance with various aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for handling collision with dynamic adaptation of SSBs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control information that indicates a set of multiple communication occasions. The communications manager 920 is capable of, configured to, or operable to support a means for receiving a first SSB configuration that configures a first SSB transmission. The communications manager 920 is capable of, configured to, or operable to support a means for receiving a second SSB configuration that configures a second SSB transmission. The communications manager 920 is capable of, configured to, or operable to support a means for selecting a set of the set of multiple communication occasions for use by the UE, where the set of the set of multiple communication occasions is selected to avoid overlap with the first SSB transmission and the second SSB transmission. The communications manager 920 is capable of, configured to, or operable to support a means for communicating via the set of the set of multiple communication occasions.

Additionally, or alternatively, the communications manager 920 may support wireless communications in accordance with examples as disclosed herein. For example, the communications manager 920 is capable of, configured to, or operable to support a means for receiving control information that indicates a set of multiple communication occasions. The communications manager 920 is capable of, configured to, or operable to support a means for receiving a first SSB configuration that configures a first SSB transmission. The communications manager 920 is capable of, configured to, or operable to support a means for receiving a second SSB configuration that configures a second SSB transmission. The communications manager 920 is capable of, configured to, or operable to support a means for selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration. The communications manager 920 is capable of, configured to, or operable to support a means for communicating via the set of the set of multiple communication occasions.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for handling collision with dynamic adaptation of SSBs as described herein, or the at least one processor 940 and the at least one memory 930 may be otherwise configured to, individually or collectively, perform or support such operations.

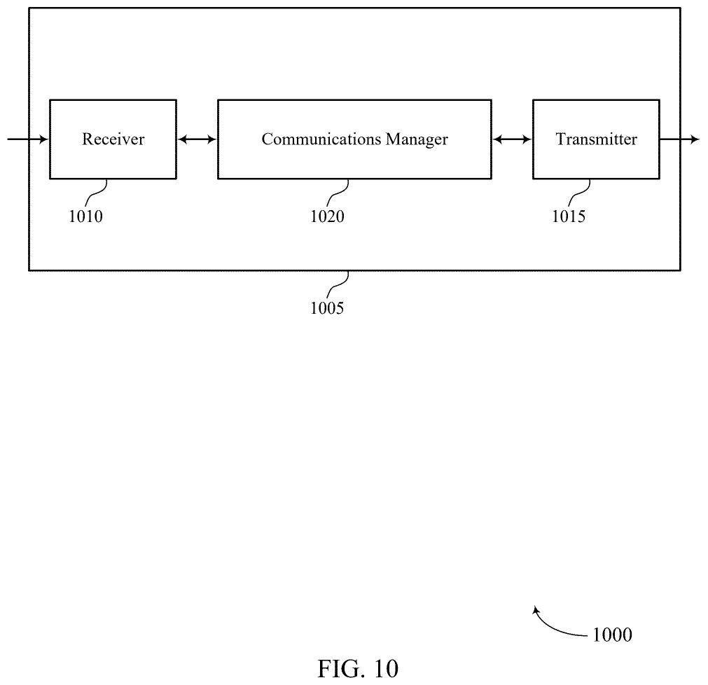

FIG. 10 shows a block diagram 1000 of a device 1005 that supports techniques for handling collision with dynamic adaptation of SSBs in accordance with various aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for handling collision with dynamic adaptation of SSBs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting control information that indicates a set of multiple communication occasions. The communications manager 1020 is capable of, configured to, or operable to support a means for outputting a first SSB configuration that configures a first SSB transmission. The communications manager 1020 is capable of, configured to, or operable to support a means for outputting a second SSB configuration that configures a second SSB transmission. The communications manager 1020 is capable of, configured to, or operable to support a means for communicating via a set of the set of multiple communication occasions, where the set of the set of multiple communication occasions is selected to avoid overlap with the first SSB transmission and the second SSB transmission.

Additionally, or alternatively, the communications manager 1020 may support wireless communications in accordance with examples as disclosed herein. For example, the communications manager 1020 is capable of, configured to, or operable to support a means for outputting control information that indicates a set of multiple communication occasions. The communications manager 1020 is capable of, configured to, or operable to support a means for outputting a first SSB configuration that configures a first SSB transmission. The communications manager 1020 is capable of, configured to, or operable to support a means for outputting a second SSB configuration that configures a second SSB transmission. The communications manager 1020 is capable of, configured to, or operable to support a means for communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

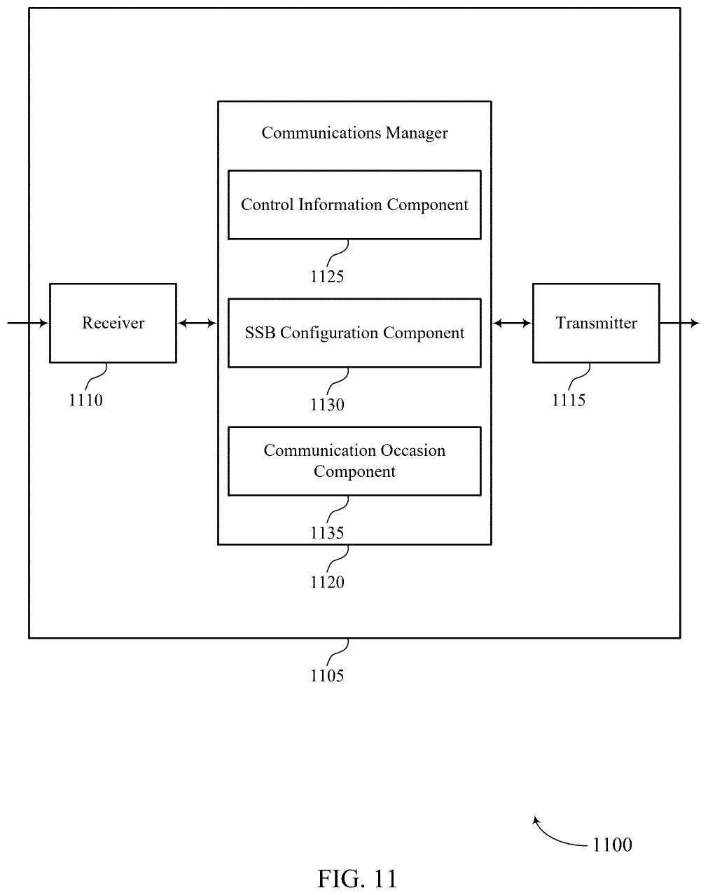

FIG. 11 shows a block diagram 1100 of a device 1105 that supports techniques for handling collision with dynamic adaptation of SSBs in accordance with various aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for handling collision with dynamic adaptation of SSBs as described herein. For example, the communications manager 1120 may include a control information component 1125, an SSB configuration component 1130, a communication occasion component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The control information component 1125 is capable of, configured to, or operable to support a means for outputting control information that indicates a set of multiple communication occasions. The SSB configuration component 1130 is capable of, configured to, or operable to support a means for outputting a first SSB configuration that configures a first SSB transmission. The SSB configuration component 1130 is capable of, configured to, or operable to support a means for outputting a second SSB configuration that configures a second SSB transmission. The communication occasion component 1135 is capable of, configured to, or operable to support a means for communicating via a set of the set of multiple communication occasions, where the set of the set of multiple communication occasions is selected to avoid overlap with the first SSB transmission and the second SSB transmission.

Additionally, or alternatively, the communications manager 1120 may support wireless communications in accordance with examples as disclosed herein. The control information component 1125 is capable of, configured to, or operable to support a means for outputting control information that indicates a set of multiple communication occasions. The SSB configuration component 1130 is capable of, configured to, or operable to support a means for outputting a first SSB configuration that configures a first SSB transmission. The SSB configuration component 1130 is capable of, configured to, or operable to support a means for outputting a second SSB configuration that configures a second SSB transmission. The communication occasion component 1135 is capable of, configured to, or operable to support a means for communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

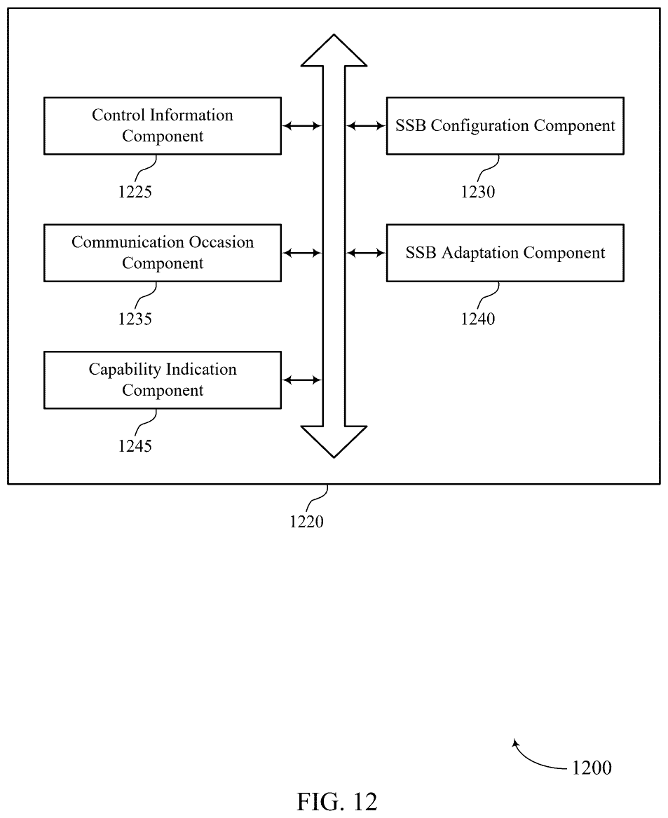

FIG. 12 shows a block diagram 1200 of a communications manager 1220 that supports techniques for handling collision with dynamic adaptation of SSBs in accordance with various aspects of the present disclosure. The communications manager 1220 may be an example of aspects of a communications manager 1020, a communications manager 1120, or both, as described herein. The communications manager 1220, or various components thereof, may be an example of means for performing various aspects of techniques for handling collision with dynamic adaptation of SSBs as described herein. For example, the communications manager 1220 may include a control information component 1225, an SSB configuration component 1230, a communication occasion component 1235, an SSB adaptation component 1240, a capability indication component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The control information component 1225 is capable of, configured to, or operable to support a means for outputting control information that indicates a set of multiple communication occasions. The SSB configuration component 1230 is capable of, configured to, or operable to support a means for outputting a first SSB configuration that configures a first SSB transmission. In some examples, the SSB configuration component 1230 is capable of, configured to, or operable to support a means for outputting a second SSB configuration that configures a second SSB transmission. The communication occasion component 1235 is capable of, configured to, or operable to support a means for communicating via a set of the set of multiple communication occasions, where the set of the set of multiple communication occasions is selected to avoid overlap with the first SSB transmission and the second SSB transmission.

In some examples, the first SSB configuration configures a first set of SSB transmissions in accordance with a first periodicity and the second SSB configuration configures a second set of SSB transmissions in accordance with a second periodicity that is different from the first periodicity. In some examples, the first set of SSB transmissions include the first SSB transmission and the second set of SSB transmissions include the second SSB transmission.

In some examples, the set of the set of multiple communication occasions is selected to avoid overlap with the first SSB transmission based on the second periodicity being greater than the first periodicity. In some examples, at least one of the set of multiple communication occasions is canceled based on overlapping with the first SSB transmission.

In some examples, the SSB adaptation component 1240 is capable of, configured to, or operable to support a means for outputting a signal configuring an SSB adaptation scheme, where the set of the set of multiple communication occasions is selected based on the SSB adaptation scheme.

In some examples, the capability indication component 1245 is capable of, configured to, or operable to support a means for obtaining, from a UE, a capability indication indicating that the UE is capable of selecting the set of the set of multiple communication occasions to avoid overlap with the first SSB transmission and the second SSB transmission.

In some examples, the set of multiple communication occasions includes downlink monitoring occasions, uplink transmission occasions corresponding to one or more configured grants, or both.

In some examples, the overlap includes at least one of a complete overlap with the first SSB transmission and the second SSB transmission, a partial overlap with the first SSB transmission and the second SSB transmission, or overlap between a threshold quantity of symbols prior to or after the set of multiple communication occasions and the first SSB transmission and the second SSB transmission.

Additionally, or alternatively, the communications manager 1220 may support wireless communications in accordance with examples as disclosed herein. In some examples, the control information component 1225 is capable of, configured to, or operable to support a means for outputting control information that indicates a set of multiple communication occasions. In some examples, the SSB configuration component 1230 is capable of, configured to, or operable to support a means for outputting a first SSB configuration that configures a first SSB transmission. In some examples, the SSB configuration component 1230 is capable of, configured to, or operable to support a means for outputting a second SSB configuration that configures a second SSB transmission. In some examples, the communication occasion component 1235 is capable of, configured to, or operable to support a means for communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

In some examples, the first SSB configuration configures a first set of SSB transmissions in accordance with a first periodicity and the second SSB configuration configures a second set of SSB transmissions in accordance with a second periodicity that is different from the first periodicity. In some examples, the first set of SSB transmissions include the first SSB transmission and the second set of SSB transmissions include the second SSB transmission.

In some examples, at least one of the set of multiple communication occasions is canceled based on overlapping with the second SSB transmission. In some examples, a communication occasion of the set of multiple communication occasions is canceled after outputting the first SSB configuration and prior to outputting the second SSB configuration. In some examples, the communication occasion is canceled based on the communication occasion overlapping with the first SSB transmission.

In some examples, the canceled communication occasion is activated based on outputting the second SSB configuration. In some examples, the canceled communication occasion does not overlap with the second SSB transmission.

In some examples, the SSB adaptation component 1240 is capable of, configured to, or operable to support a means for outputting a signal configuring an SSB adaptation scheme, where the set of the set of multiple communication occasions is selected based on the SSB adaptation scheme.

In some examples, the second SSB configuration is activated after a threshold time period has elapsed after outputting the second SSB configuration. In some examples, the capability indication component 1245 is capable of, configured to, or operable to support a means for obtaining, from a UE, a capability indication indicating that the UE is capable of selecting the set of the set of multiple communication occasions to avoid overlap with the second SSB transmission in accordance with the most recently activated configuration of the first SSB configuration and the second SSB configuration.

In some examples, the second SSB configuration is activated after the first SSB configuration is activated. In some examples, the set of multiple communication occasions includes downlink monitoring occasions, uplink transmission occasions corresponding to one or more configured grants, or both.

In some examples, the overlap includes at least one of a complete overlap with the second SSB transmission, a partial overlap with the second SSB transmission, or overlap between a threshold quantity of symbols prior to or after the set of multiple communication occasions and the second SSB transmission. In some examples, the set of the multiple of communication occasions is selected in accordance with the first SSB configuration and the second SSB configuration.

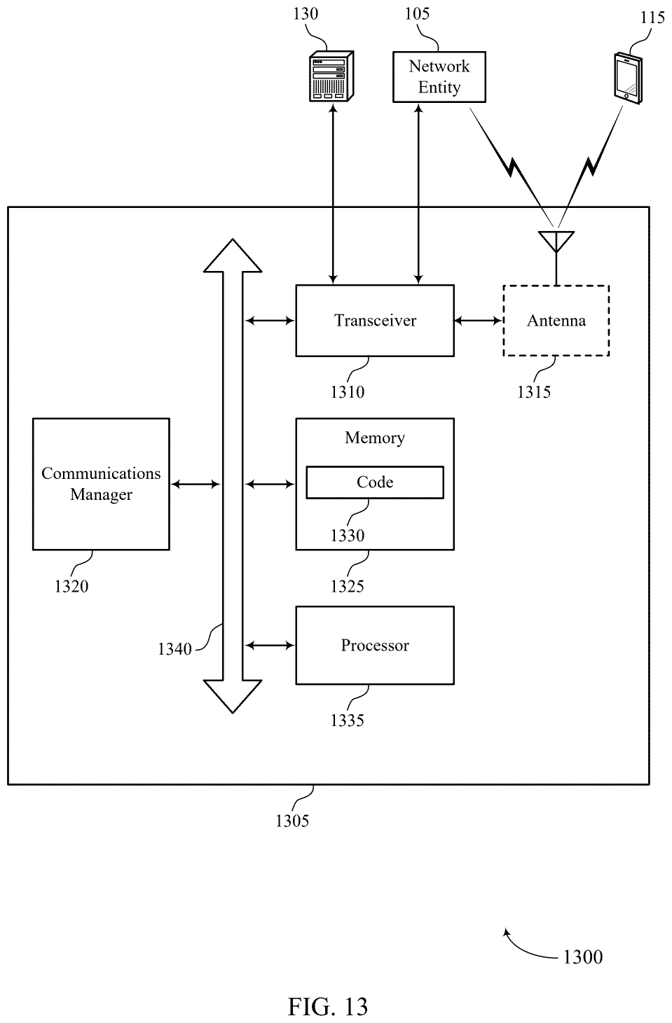

FIG. 13 shows a diagram of a system 1300 including a device 1305 that supports techniques for handling collision with dynamic adaptation of SSBs in accordance with various aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for handling collision with dynamic adaptation of SSBs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting control information that indicates a set of multiple communication occasions. The communications manager 1320 is capable of, configured to, or operable to support a means for outputting a first SSB configuration that configures a first SSB transmission. The communications manager 1320 is capable of, configured to, or operable to support a means for outputting a second SSB configuration that configures a second SSB transmission. The communications manager 1320 is capable of, configured to, or operable to support a means for communicating via a set of the set of multiple communication occasions, where the set of the set of multiple communication occasions is selected to avoid overlap with the first SSB transmission and the second SSB transmission.

Additionally, or alternatively, the communications manager 1320 may support wireless communications in accordance with examples as disclosed herein. For example, the communications manager 1320 is capable of, configured to, or operable to support a means for outputting control information that indicates a set of multiple communication occasions. The communications manager 1320 is capable of, configured to, or operable to support a means for outputting a first SSB configuration that configures a first SSB transmission. The communications manager 1320 is capable of, configured to, or operable to support a means for outputting a second SSB configuration that configures a second SSB transmission. The communications manager 1320 is capable of, configured to, or operable to support a means for communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration.

By including or configuring the communications manager 1320 in accordance with examples as described herein, the device 1305 may support techniques for improved communication reliability, reduced latency, improved user experience related to reduced processing, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for handling collision with dynamic adaptation of SSBs as described herein, or the at least one processor 1335 and the at least one memory 1325 may be otherwise configured to, individually or collectively, perform or support such operations.

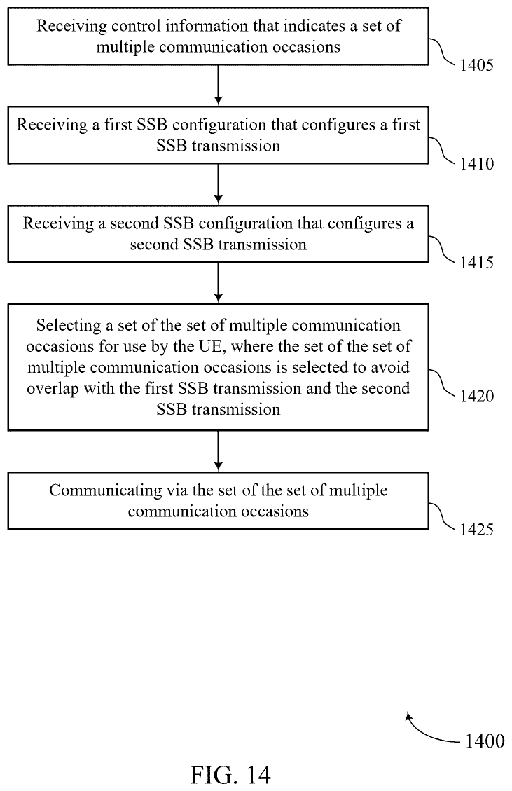

FIG. 14 shows a flowchart illustrating a method 1400 that supports techniques for handling collision with dynamic adaptation of SSBs in accordance with various aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control information that indicates a set of multiple communication occasions. The operations of 1405 may be performed in accordance with examples as disclosed herein. In some examples, aspects of the operations of 1405 may be performed by a control information component 825 as described with reference to FIG. 8.

At 1410, the method may include receiving a first SSB configuration that configures a first SSB transmission. The operations of 1410 may be performed in accordance with examples as disclosed herein. In some examples, aspects of the operations of 1410 may be performed by an SSB configuration component 830 as described with reference to FIG. 8.

At 1415, the method may include receiving a second SSB configuration that configures a second SSB transmission. The operations of 1415 may be performed in accordance with examples as disclosed herein. In some examples, aspects of the operations of 1415 may be performed by an SSB configuration component 830 as described with reference to FIG. 8.

At 1420, the method may include selecting a set of the set of multiple communication occasions for use by the UE, where the set of the set of multiple communication occasions is selected to avoid overlap with the first SSB transmission and the second SSB transmission. The operations of 1420 may be performed in accordance with examples as disclosed herein. In some examples, aspects of the operations of 1420 may be performed by a communication occasion component 835 as described with reference to FIG. 8.

At 1425, the method may include communicating via the set of the set of multiple communication occasions. The operations of 1425 may be performed in accordance with examples as disclosed herein. In some examples, aspects of the operations of 1425 may be performed by a communication occasion component 835 as described with reference to FIG. 8.

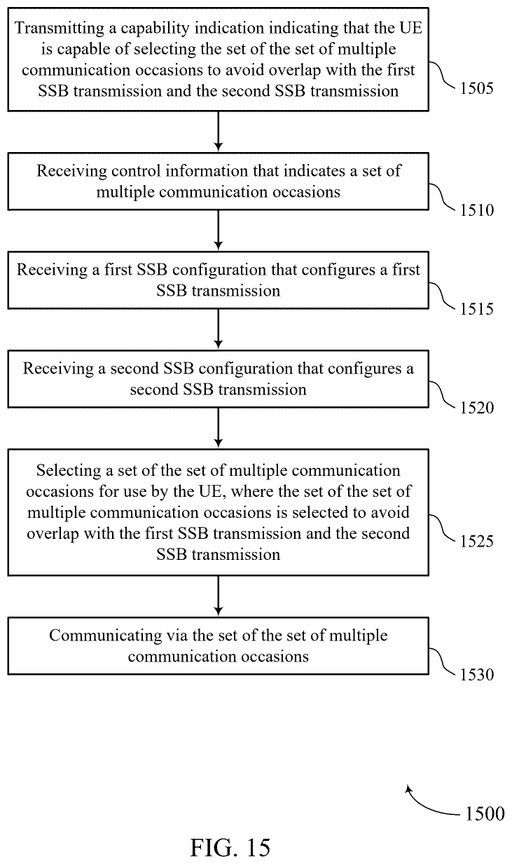

FIG. 15 shows a flowchart illustrating a method 1500 that supports techniques for handling collision with dynamic adaptation of SSBs in accordance with various aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a capability indication indicating that the UE is capable of selecting the set of the set of multiple communication occasions to avoid overlap with the first SSB transmission and the second SSB transmission. The operations of 1505 may be performed in accordance with examples as disclosed herein. In some examples, aspects of the operations of 1505 may be performed by a capability component 845 as described with reference to FIG. 8.

At 1510, the method may include receiving control information that indicates a set of multiple communication occasions. The operations of 1510 may be performed in accordance with examples as disclosed herein. In some examples, aspects of the operations of 1510 may be performed by a control information component 825 as described with reference to FIG. 8.

At 1515, the method may include receiving a first SSB configuration that configures a first SSB transmission. The operations of 1515 may be performed in accordance with examples as disclosed herein. In some examples, aspects of the operations of 1515 may be performed by an SSB configuration component 830 as described with reference to FIG. 8.

At 1520, the method may include receiving a second SSB configuration that configures a second SSB transmission. The operations of 1520 may be performed in accordance with examples as disclosed herein. In some examples, aspects of the operations of 1520 may be performed by an SSB configuration component 830 as described with reference to FIG. 8.

At 1525, the method may include selecting a set of the set of multiple communication occasions for use by the UE, where the set of the set of multiple communication occasions is selected to avoid overlap with the first SSB transmission and the second SSB transmission. The operations of 1525 may be performed in accordance with examples as disclosed herein. In some examples, aspects of the operations of 1525 may be performed by a communication occasion component 835 as described with reference to FIG. 8.

At 1530, the method may include communicating via the set of the set of multiple communication occasions. The operations of 1530 may be performed in accordance with examples as disclosed herein. In some examples, aspects of the operations of 1530 may be performed by a communication occasion component 835 as described with reference to FIG. 8.

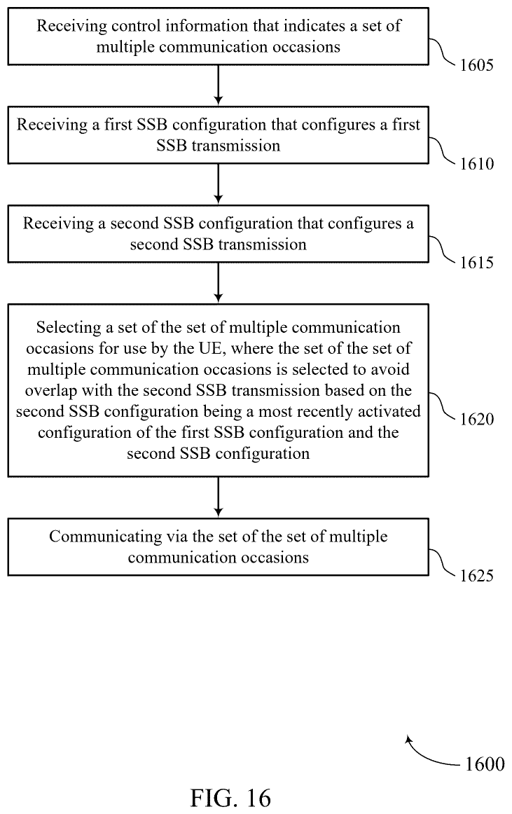

FIG. 16 shows a flowchart illustrating a method 1600 that supports techniques for handling collision with dynamic adaptation of SSBs in accordance with various aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving control information that indicates a set of multiple communication occasions. The operations of 1605 may be performed in accordance with examples as disclosed herein. In some examples, aspects of the operations of 1605 may be performed by a control information component 825 as described with reference to FIG. 8.

At 1610, the method may include receiving a first SSB configuration that configures a first SSB transmission. The operations of 1610 may be performed in accordance with examples as disclosed herein. In some examples, aspects of the operations of 1610 may be performed by an SSB configuration component 830 as described with reference to FIG. 8.

At 1615, the method may include receiving a second SSB configuration that configures a second SSB transmission. The operations of 1615 may be performed in accordance with examples as disclosed herein. In some examples, aspects of the operations of 1615 may be performed by an SSB configuration component 830 as described with reference to FIG. 8.

At 1620, the method may include selecting a set of the set of multiple communication occasions for use by the UE, where the set of the set of multiple communication occasions is selected to avoid overlap with the second SSB transmission based on the second SSB configuration being a most recently activated configuration of the first SSB configuration and the second SSB configuration. The operations of 1620 may be performed in accordance with examples as disclosed herein. In some examples, aspects of the operations of 1620 may be performed by a communication occasion component 835 as described with reference to FIG. 8.

At 1625, the method may include communicating via the set of the set of multiple communication occasions. The operations of 1625 may be performed in accordance with examples as disclosed herein. In some examples, aspects of the operations of 1625 may be performed by a communication occasion component 835 as described with reference to FIG. 8.

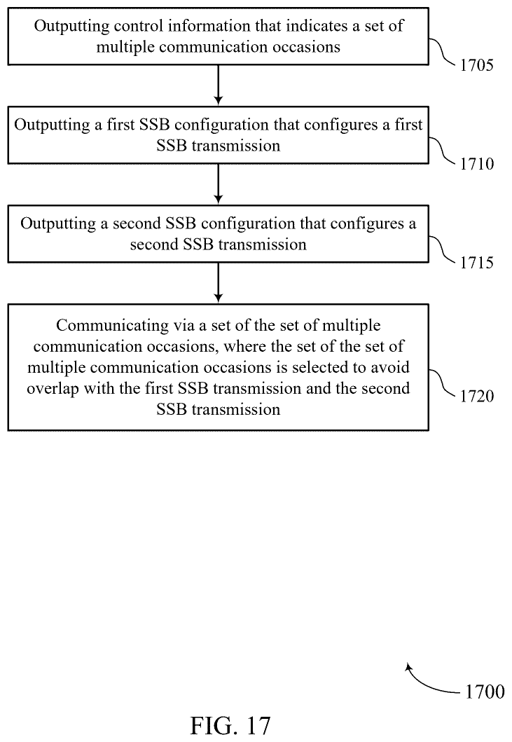

FIG. 17 shows a flowchart illustrating a method 1700 that supports techniques for handling collision with dynamic adaptation of SSBs in accordance with various aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting control information that indicates a set of multiple communication occasions. The operations of 1705 may be performed in accordance with examples as disclosed herein. In some examples, aspects of the operations of 1705 may be performed by a control information component 1225 as described with reference to FIG. 12.

At 1710, the method may include outputting a first SSB configuration that configures a first SSB transmission. The operations of 1710 may be performed in accordance with examples as disclosed herein. In some examples, aspects of the operations of 1710 may be performed by an SSB configuration component 1230 as described with reference to FIG. 12.

At 1715, the method may include outputting a second SSB configuration that configures a second SSB transmission. The operations of 1715 may be performed in accordance with examples as disclosed herein. In some examples, aspects of the operations of 1715 may be performed by an SSB configuration component 1230 as described with reference to FIG. 12.

At 1720, the method may include communicating via a set of the set of multiple communication occasions, where the set of the set of multiple communication occasions is selected to avoid overlap with the first SSB transmission and the second SSB transmission. The operations of 1720 may be performed in accordance with examples as disclosed herein. In some examples, aspects of the operations of 1720 may be performed by a communication occasion component 1235 as described with reference to FIG. 12.

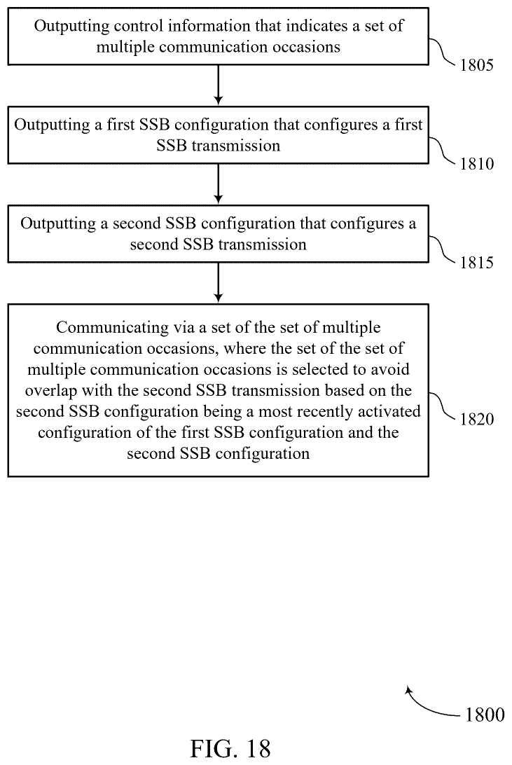

FIG. 18 shows a flowchart illustrating a method 1800 that supports techniques for handling collision with dynamic adaptation of SSBs in accordance with various aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting control information that indicates a set of multiple communication occasions. The operations of 1805 may be performed in accordance with examples as disclosed herein. In some examples, aspects of the operations of 1805 may be performed by a control information component 1225 as described with reference to FIG. 12.

At 1810, the method may include outputting a first SSB configuration that configures a first SSB transmission. The operations of 1810 may be performed in accordance with examples as disclosed herein. In some examples, aspects of the operations of 1810 may be performed by an SSB configuration component 1230 as described with reference to FIG. 12.

At 1815, the method may include outputting a second SSB configuration that configures a second SSB transmission. The operations of 1815 may be performed in accordance with examples as disclosed herein. In some examples, aspects of the operations of 1815 may be performed by an SSB configuration component 1230 as described with reference to FIG. 12.

At 1820, the method may include communicating via a set of the set of multiple communication occasions, where the set of the set of multiple communication occasions is selected to avoid overlap with the second SSB transmission based on the second SSB configuration being a most recently activated configuration of the first SSB configuration and the second SSB configuration. The operations of 1820 may be performed in accordance with examples as disclosed herein. In some examples, aspects of the operations of 1820 may be performed by a communication occasion component 1235 as described with reference to FIG. 12.

The following provides an overview of aspects of the present disclosure:

Aspect 1: A method for wireless communications at a UE, comprising: receiving control information that indicates a plurality of communication occasions; receiving a first synchronization signal block (SSB) configuration that configures a first SSB transmission; receiving a second SSB configuration that configures a second SSB transmission; selecting a set of the plurality of communication occasions for use by the UE, wherein the set of the plurality of communication occasions is selected to avoid overlap with the first SSB transmission and the second SSB transmission; and communicating via the set of the plurality of communication occasions.

Aspect 2: The method of aspect 1, wherein the first SSB configuration configures a first set of SSB transmissions in accordance with a first periodicity and the second SSB configuration configures a second set of SSB transmissions in accordance with a second periodicity that is different from the first periodicity, and the first set of SSB transmissions include the first SSB transmission and the second set of SSB transmissions include the second SSB transmission.

Aspect 3: The method of aspect 2, wherein selecting the set of the plurality of communication occasions further comprises: selecting the set of the plurality of communication occasions for use by the UE to avoid overlap with the first SSB transmission based at least in part on the second periodicity being greater than the first periodicity.

Aspect 4: The method of aspect 3, wherein the set of the plurality of communication occasions is selected to exclude ones of the plurality of communication occasions that overlap with the first SSB transmission.

Aspect 5: The method of any of aspects 1 through 4, further comprising: receiving a signal configuring an SSB adaptation scheme for the UE, wherein selecting the set of the plurality of communication occasions is based at least in part on the SSB adaptation scheme.

Aspect 6: The method of any of aspects 1 through 5, further comprising: transmitting a capability indication indicating that the UE is capable of selecting the set of the plurality of communication occasions to avoid overlap with the first SSB transmission and the second SSB transmission.

Aspect 7: The method of any of aspects 1 through 6, wherein the plurality of communication occasions includes downlink monitoring occasions, uplink transmission occasions corresponding to one or more configured grants, or both.

Aspect 8: The method of any of aspects 1 through 7, wherein the overlap includes at least one of a complete overlap with the first SSB transmission and the second SSB transmission, a partial overlap with the first SSB transmission and the second SSB transmission, or overlap between a threshold quantity of symbols prior to or after the plurality of communication occasions and the first SSB transmission and the second SSB transmission.

Aspect 9: The method of any of aspects 1 through 8, wherein the set of the plurality of communication occasions is selected in accordance with the first SSB configuration and the second SSB configuration.

Aspect 10: A method for wireless communications at a UE, comprising: receiving control information that indicates a plurality of communication occasions; receiving a first synchronization signal block (SSB) configuration that configures a first SSB transmission; receiving a second SSB configuration that configures a second SSB transmission; selecting a set of the plurality of communication occasions for use by the UE, wherein the set of the plurality of communication occasions is selected to avoid overlap with the second SSB transmission based on the second SSB configuration being a most recently activated configuration of the first SSB configuration and the second SSB configuration; and communicating via the set of the plurality of communication occasions.

Aspect 11: The method of aspect 10, wherein the first SSB configuration configures a first set of SSB transmissions in accordance with a first periodicity and the second SSB configuration configures a second set of SSB transmissions in accordance with a second periodicity that is different from the first periodicity, and the first set of SSB transmissions include the first SSB transmission and the second set of SSB transmissions include the second SSB transmission.

Aspect 12: The method of aspect 11, wherein the set of the plurality of communication occasions is selected to exclude ones of the plurality of communication occasions that overlap with the second SSB transmission based at least in part on the second SSB configuration being the most recently activated configuration.

Aspect 13: The method of any of aspects 10 through 12, wherein the set of the plurality of communication occasions is selected to include ones of the plurality of communication occasions that overlap with the first SSB transmission based at least in part on the first SSB configuration not being the most recently activated configuration.

Aspect 14: The method of any of aspects 10 through 13, further comprising: receiving a signal configuring an SSB adaptation scheme for the UE, wherein selecting the set of the plurality of communication occasions is based at least in part on the SSB adaptation scheme.

Aspect 15: The method of any of aspects 10 through 14, wherein the second SSB configuration is activated after a threshold time period has elapsed after receiving the second SSB configuration.

Aspect 16: The method of any of aspects 10 through 15, further comprising: transmitting a capability indication indicating that the UE is capable of selecting the set of the plurality of communication occasions to avoid overlap with the second SSB transmission in accordance with the most recently activated configuration of the first SSB configuration and the second SSB configuration.

Aspect 17: The method of any of aspects 10 through 16, wherein the second SSB configuration is activated after the first SSB configuration is activated.

Aspect 18: The method of any of aspects 10 through 17, wherein the plurality of communication occasions includes downlink monitoring occasions, uplink transmission occasions corresponding to one or more configured grants, or both.

Aspect 19: The method of any of aspects 10 through 18, wherein the overlap includes at least one of a complete overlap with the second SSB transmission, a partial overlap with the second SSB transmission, or overlap between a threshold quantity of symbols prior to or after the plurality of communication occasions and the second SSB transmission.

Aspect 20: A method for wireless communications at a network entity, comprising: outputting control information that indicates a plurality of communication occasions; outputting a first synchronization signal block (SSB) configuration that configures a first SSB transmission; outputting a second SSB configuration that configures a second SSB transmission; and communicating via a set of the plurality of communication occasions, wherein the set of the plurality of communication occasions is selected to avoid overlap with the first SSB transmission and the second SSB transmission.

Aspect 21: The method of aspect 20, wherein the first SSB configuration configures a first set of SSB transmissions in accordance with a first periodicity and the second SSB configuration configures a second set of SSB transmissions in accordance with a second periodicity that is different from the first periodicity, and the first set of SSB transmissions include the first SSB transmission and the second set of SSB transmissions include the second SSB transmission.

Aspect 22: The method of aspect 21, wherein the set of the plurality of communication occasions is selected to avoid overlap with the first SSB transmission based at least in part on the second periodicity being greater than the first periodicity.

Aspect 23: The method of aspect 22, wherein at least one of the plurality of communication occasions is canceled based at least in part on overlapping with the first SSB transmission.

Aspect 24: The method of any of aspects 20 through 23, further comprising: outputting a signal configuring an SSB adaptation scheme, wherein the set of the plurality of communication occasions is selected based at least in part on the SSB adaptation scheme.

Aspect 25: The method of any of aspects 20 through 24, further comprising: obtaining, from a UE, a capability indication indicating that the UE is capable of selecting the set of the plurality of communication occasions to avoid overlap with the first SSB transmission and the second SSB transmission.

Aspect 26: The method of any of aspects 20 through 25, wherein the plurality of communication occasions includes downlink monitoring occasions, uplink transmission occasions corresponding to one or more configured grants, or both.

Aspect 27: The method of any of aspects 20 through 26, wherein the overlap includes at least one of a complete overlap with the first SSB transmission and the second SSB transmission, a partial overlap with the first SSB transmission and the second SSB transmission, or overlap between a threshold quantity of symbols prior to or after the plurality of communication occasions and the first SSB transmission and the second SSB transmission.

Aspect 28: The method of any of aspects 20 through 27, wherein the set of the plurality of communication occasions is selected in accordance with the first SSB configuration and the second SSB configuration.

Aspect 29: A method for wireless communications at a network entity, comprising: outputting control information that indicates a plurality of communication occasions; outputting a first synchronization signal block (SSB) configuration that configures a first SSB transmission; outputting a second SSB configuration that configures a second SSB transmission; and communicating via a set of the plurality of communication occasions, wherein the set of the plurality of communication occasions is selected to avoid overlap with the second SSB transmission based on the second SSB configuration being a most recently activated configuration of the first SSB configuration and the second SSB configuration.

Aspect 30: The method of aspect 29, wherein the first SSB configuration configures a first set of SSB transmissions in accordance with a first periodicity and the second SSB configuration configures a second set of SSB transmissions in accordance with a second periodicity that is different from the first periodicity, and the first set of SSB transmissions include the first SSB transmission and the second set of SSB transmissions include the second SSB transmission.

Aspect 31: The method of any of aspects 29 through 30, wherein at least one of the plurality of communication occasions is canceled based at least in part on overlapping with the second SSB transmission.

Aspect 32: The method of any of aspects 29 through 31, wherein a communication occasion of the plurality of communication occasions is canceled after outputting the first SSB configuration and prior to outputting the second SSB configuration, and the communication occasion is canceled based at least in part on the communication occasion overlapping with the first SSB transmission.

Aspect 33: The method of aspect 32, wherein the canceled communication occasion is activated based at least in part on outputting the second SSB configuration, and the canceled communication occasion does not overlap with the second SSB transmission.

Aspect 34: The method of any of aspects 29 through 33, further comprising: outputting a signal configuring an SSB adaptation scheme, wherein the set of the plurality of communication occasions is selected based at least in part on the SSB adaptation scheme.

Aspect 35: The method of any of aspects 29 through 34, wherein the second SSB configuration is activated after a threshold time period has elapsed after outputting the second SSB configuration.

Aspect 36: The method of any of aspects 29 through 35, further comprising: obtaining, from a UE, a capability indication indicating that the UE is capable of selecting the set of the plurality of communication occasions to avoid overlap with the second SSB transmission in accordance with the most recently activated configuration of the first SSB configuration and the second SSB configuration.

Aspect 37: The method of any of aspects 29 through 36, wherein the second SSB configuration is activated after the first SSB configuration is activated.

Aspect 38: The method of any of aspects 29 through 37, wherein the plurality of communication occasions includes downlink monitoring occasions, uplink transmission occasions corresponding to one or more configured grants, or both.

Aspect 39: The method of any of aspects 29 through 38, wherein the overlap includes at least one of a complete overlap with the second SSB transmission, a partial overlap with the second SSB transmission, or overlap between a threshold quantity of symbols prior to or after the plurality of communication occasions and the second SSB transmission.

Aspect 40: A UE for wireless communications, comprising one or more memories storing processor-executable code, and one or more processors coupled with the one or more memories and individually or collectively operable to execute the code to cause the UE to perform a method of any of aspects 1 through 8.

Aspect 41: A UE for wireless communications, comprising at least one means for performing a method of any of aspects 1 through 8.

Aspect 42: A non-transitory computer-readable medium storing code for wireless communications, the code comprising instructions executable by one or more processors to perform a method of any of aspects 1 through 8.

Aspect 43: A UE for wireless communications, comprising one or more memories storing processor-executable code, and one or more processors coupled with the one or more memories and individually or collectively operable to execute the code to cause the UE to perform a method of any of aspects 10 through 19.

Aspect 44: A UE for wireless communications, comprising at least one means for performing a method of any of aspects 10 through 19.

Aspect 45: A non-transitory computer-readable medium storing code for wireless communications, the code comprising instructions executable by one or more processors to perform a method of any of aspects 10 through 19.

Aspect 46: A network entity for wireless communications, comprising one or more memories storing processor-executable code, and one or more processors coupled with the one or more memories and individually or collectively operable to execute the code to cause the network entity to perform a method of any of aspects 20 through 27.

Aspect 47: A network entity for wireless communications, comprising at least one means for performing a method of any of aspects 20 through 27.

Aspect 48: A non-transitory computer-readable medium storing code for wireless communications, the code comprising instructions executable by one or more processors to perform a method of any of aspects 20 through 27.

Aspect 49: A network entity for wireless communications, comprising one or more memories storing processor-executable code, and one or more processors coupled with the one or more memories and individually or collectively operable to execute the code to cause the network entity to perform a method of any of aspects 29 through 39.

Aspect 50: A network entity for wireless communications, comprising at least one means for performing a method of any of aspects 29 through 39.

Aspect 51: A non-transitory computer-readable medium storing code for wireless communications, the code comprising instructions executable by one or more processors to perform a method of any of aspects 29 through 39.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a characteristic or performing a function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that indicates a plurality of communication occasions;
receive a first synchronization signal block (SSB) configuration that configures a first SSB transmission;
receive a second SSB configuration that configures a second SSB transmission;
select a set of the plurality of communication occasions for use by the UE, wherein the set of the plurality of communication occasions is selected to avoid overlap with the first SSB transmission and the second SSB transmission; and
communicate via the set of the plurality of communication occasions.

2. The UE of claim 1, wherein:
the first SSB configuration configures a first set of SSB transmissions in accordance with a first periodicity and the second SSB configuration configures a second set of SSB transmissions in accordance with a second periodicity that is different from the first periodicity, and
the first set of SSB transmissions include the first SSB transmission and the second set of SSB transmissions include the second SSB transmission.

3. The UE of claim 2, wherein, to select the set of the plurality of communication occasions, the one or more processors are individually or collectively further operable to execute the code to cause the UE to:
select the set of the plurality of communication occasions for use by the UE to avoid overlap with the first SSB transmission based at least in part on the second periodicity being greater than the first periodicity.

4. The UE of claim 3, wherein the set of the plurality of communication occasions is selected to exclude ones of the plurality of communication occasions that overlap with the first SSB transmission.

5. The UE of claim 1, wherein the one or more processors are individually or collectively further operable to execute the code to cause the UE to:
receive a signal configuring an SSB adaptation scheme for the UE, wherein selecting the set of the plurality of communication occasions is based at least in part on the SSB adaptation scheme.

6. The UE of claim 1, wherein the one or more processors are individually or collectively further operable to execute the code to cause the UE to:
transmit a capability indication indicating that the UE is capable of selecting the set of the plurality of communication occasions to avoid overlap with the first SSB transmission and the second SSB transmission.

7. The UE of claim 1, wherein the plurality of communication occasions includes downlink monitoring occasions, uplink transmission occasions corresponding to one or more configured grants, or both.

8. The UE of claim 1, wherein the overlap includes at least one of a complete overlap with the first SSB transmission and the second SSB transmission, a partial overlap with the first SSB transmission and the second SSB transmission, or overlap between a threshold quantity of symbols prior to or after the plurality of communication occasions and the first SSB transmission and the second SSB transmission.

9. The UE of claim 1, wherein the set of the plurality of communication occasions is selected in accordance with the first SSB configuration and the second SSB configuration.

10. A user equipment (UE), comprising:
one or more memories storing processor-executable code; and
one or more processors coupled with the one or more memories and individually or collectively operable to execute the code to cause the UE to:
receive control information that indicates a plurality of communication occasions;
receive a first synchronization signal block (SSB) configuration that configures a first SSB transmission;
receive a second SSB configuration that configures a second SSB transmission;
select a set of the plurality of communication occasions for use by the UE, wherein the set of the plurality of communication occasions is selected to avoid overlap with the second SSB transmission based on the second SSB configuration being a most recently activated configuration of the first SSB configuration and the second SSB configuration; and
communicate via the set of the plurality of communication occasions.

11. The UE of claim 10, wherein:
the first SSB configuration configures a first set of SSB transmissions in accordance with a first periodicity and the second SSB configuration configures a second set of SSB transmissions in accordance with a second periodicity that is different from the first periodicity, and
the first set of SSB transmissions include the first SSB transmission and the second set of SSB transmissions include the second SSB transmission.

12. The UE of claim 11, wherein the set of the plurality of communication occasions is selected to exclude ones of the plurality of communication occasions that overlap with the second SSB transmission based at least in part on the second SSB configuration being the most recently activated configuration.

13. The UE of claim 10, wherein the set of the plurality of communication occasions is selected to include ones of the plurality of communication occasions that overlap with the first SSB transmission based at least in part on the first SSB configuration not being the most recently activated configuration.

14. The UE of claim 10, wherein the one or more processors are individually or collectively further operable to execute the code to cause the UE to:
receive a signal configuring an SSB adaptation scheme for the UE, wherein selecting the set of the plurality of communication occasions is based at least in part on the SSB adaptation scheme.

15. The UE of claim 10, wherein the second SSB configuration is activated after a threshold time period has elapsed after receiving the second SSB configuration.

16. The UE of claim 10, wherein the one or more processors are individually or collectively further operable to execute the code to cause the UE to:
transmit a capability indication indicating that the UE is capable of selecting the set of the plurality of communication occasions to avoid overlap with the second SSB transmission in accordance with the most recently activated configuration of the first SSB configuration and the second SSB configuration.

17. The UE of claim 10, wherein the second SSB configuration is activated after the first SSB configuration is activated.

18. The UE of claim 10, wherein the plurality of communication occasions includes downlink monitoring occasions, uplink transmission occasions corresponding to one or more configured grants, or both.

19. The UE of claim 10, wherein the overlap includes at least one of a complete overlap with the second SSB transmission, a partial overlap with the second SSB transmission, or overlap between a threshold quantity of symbols prior to or after the plurality of communication occasions and the second SSB transmission.

20. A network entity, comprising:
one or more memories storing processor-executable code; and
one or more processors coupled with the one or more memories and individually or collectively operable to execute the code to cause the network entity to:
output control information that indicates a plurality of communication occasions;
output a first synchronization signal block (SSB) configuration that configures a first SSB transmission;
output a second SSB configuration that configures a second SSB transmission; and
communicate via a set of the plurality of communication occasions, wherein the set of the plurality of communication occasions is selected to avoid overlap with the first SSB transmission and the second SSB transmission.

21. The network entity of claim 20, wherein:
the first SSB configuration configures a first set of SSB transmissions in accordance with a first periodicity and the second SSB configuration configures a second set of SSB transmissions in accordance with a second periodicity that is different from the first periodicity, and
the first set of SSB transmissions include the first SSB transmission and the second set of SSB transmissions include the second SSB transmission.

22. The network entity of claim 21, wherein the set of the plurality of communication occasions is selected to avoid overlap with the first SSB transmission based at least in part on the second periodicity being greater than the first periodicity.

23. The network entity of claim 22, wherein at least one of the plurality of communication occasions is canceled based at least in part on overlapping with the first SSB transmission.

24. The network entity of claim 20, wherein the one or more processors are individually or collectively further operable to execute the code to cause the network entity to:
output a signal configuring an SSB adaptation scheme, wherein the set of the plurality of communication occasions is selected based at least in part on the SSB adaptation scheme.

25. The network entity of claim 20, wherein the one or more processors are individually or collectively further operable to execute the code to cause the network entity to:
obtain, from a user equipment (UE), a capability indication indicating that the UE is capable of selecting the set of the plurality of communication occasions to avoid overlap with the first SSB transmission and the second SSB transmission.

26. The network entity of claim 20, wherein the overlap includes at least one of a complete overlap with the first SSB transmission and the second SSB transmission, a partial overlap with the first SSB transmission and the second SSB transmission, or overlap between a threshold quantity of symbols prior to or after the plurality of communication occasions and the first SSB transmission and the second SSB transmission.

27. The network entity of claim 20, wherein the set of the plurality of communication occasions is selected in accordance with the first SSB configuration and the second SSB configuration.

28. A network entity, comprising:
one or more memories storing processor-executable code; and
one or more processors coupled with the one or more memories and individually or collectively operable to execute the code to cause the network entity to:
output control information that indicates a plurality of communication occasions;
output a first synchronization signal block (SSB) configuration that configures a first SSB transmission;
output a second SSB configuration that configures a second SSB transmission; and
communicate via a set of the plurality of communication occasions, wherein the set of the plurality of communication occasions is selected to avoid overlap with the second SSB transmission based on the second SSB configuration being a most recently activated configuration of the first SSB configuration and the second SSB configuration.

29. The network entity of claim 28, wherein:
the first SSB configuration configures a first set of SSB transmissions in accordance with a first periodicity and the second SSB configuration configures a second set of SSB transmissions in accordance with a second periodicity that is different from the first periodicity, and
the first set of SSB transmissions include the first SSB transmission and the second set of SSB transmissions include the second SSB transmission.

30. The network entity of claim 28, wherein at least one of the plurality of communication occasions is canceled based at least in part on overlapping with the second SSB transmission.
